(19) United States
(12) Patent Application Publication
(10) Pub. No.: US 2005/0192888 A1
(43) Pub. Date: Sep. 1, 2005

(54) System and method to instantaneously settle a securities transaction over a network

(76) Inventors: James P. Lennane, Naples, FL (US); Bridget O'Flaherty, Davis, CA (US); John Serences, Carmichael, CA (US); Bill Henley, Loomis, CA (US); Kyle Shelton, Cameron Park, CA (US); John Swann, Davis, CA (US)

Correspondence Address: GROSSMAN & FLIGHT LLC, Suite 4220, 20 North Wacker Drive, Chicago, IL, 60606-6357, US

(21) Appl. No.: 10/977,697

(22) Filed: Oct. 29, 2004

Related U.S. Application Data
(60) Provisional application No. 60/516,568, filed on Oct. 31, 2003.

(51) Int. Cl. G06F 17/60

(52) U.S. Cl. 705/37; 705/35

(57) ABSTRACT

Methods and apparatus for instantaneously settling the transaction of securities over a network are disclosed. In one example, the trading system holds all users' money and securities and users are only able to exchange securities within the trading system. The trading system checks the users' accounts before initiating a buy or sell order thereby facilitating the instantaneous settlement of the transaction upon matching the orders which occur within the system.

### CROSS REFERENCE TO RELATED APPLICATIONS

This application incorporates by reference and claims the benefit of U.S. Provisional Application No. 60/516,568, filed Oct. 31, 2003.

### TECHNICAL FIELD

This application relates to securities trading systems and, more particularly, to a system and method to instantaneously settle securities transactions over a network.

### BACKGROUND

In the United States, the trading of securities is closely regulated under the Securities Exchange Act of 1934, 15 U.S.C. §§78a-78mm. The term “security” is defined in 15 U.S.C. §78c(a)(I0) as “any note, stock, treasury stock, security future, bond, debenture, certificate of interest or participation in any profit-sharing agreement or in any oil, gas, or other mineral royalty or lease, any collateral-trust certificate, preorganization certificate or subscription, transferable share, investment contract, voting-trust certificate, certificate of deposit for a security, any put, call, straddle, option, or privilege on any security, certificate of deposit, or group or index of securities (including any interest therein or based on the value thereof), or any put, call, straddle, option, or privilege entered into on a national securities exchange relating to foreign currency, or in general, any instrument commonly known as a ‘security’; or any certificate of interest or participation in, temporary or interim certificate for, receipt for, or warrant or right to subscribe to or purchase, any of the foregoing; but shall not include currency or any note, draft, bill of exchange, or banker's acceptance, which has a maturity at the time of issuance of not exceeding nine months, exclusive of days of grace, or any renewal thereof the maturity of which is likewise limited.” Stocks are specific instances of securities. Although the preferred embodiment is primarily concerned with computerized stock trading, it is fully applicable to trading of any securities.

Securities are conventionally traded on exchanges. As set forth in 15 U.S.C. §78c(a)(1), the term “exchange” means “any organization, association, or group of persons, whether incorporated or unincorporated, which constitutes, maintains, or provides a market place or facilities for bringing together purchasers and sellers of securities or for otherwise performing with respect to securities the functions commonly performed by a stock exchange as that term is generally understood, and includes the market place and the market facilities maintained by such exchange.” Well known exchanges include, for example, the New York Stock Exchange, the American Stock Exchange, and NASDAQ. Such known exchanges are referred to herein as “national exchanges.”

Usually securities are traded through brokers and dealers, who frequently use an on-line system to receive orders and facilitate trades. As set forth in 17 C.F.R. §§240.17a-3(a)(16)(ii)(A) a broker/dealer trading system is “any facility, other than a national securities exchange, an exchange exempt from registration based on limited volume, or an alternative trading system as defined in Regulation ATS, §§ 242.300 through 242.303 of this chapter, that provides a mechanism, automated in fall or in part, for collecting, receiving, disseminating, or displaying system orders and facilitating agreement to the basic terms of a purchase or sale of a security between a user and the sponsor, or between two users of the sponsor, through use of the internal broker-dealer system or through the broker or dealer sponsor of such system.”

Investors who buy and sell securities must settle their security transactions in three business days. This settlement cycle is known as “T+3,” which is shorthand for trade date plus three days. When investors buy securities, the brokerage firm selling securities on behalf of the seller must receive payment no later than three business days after the trade is executed. Conversely, when investors sell securities, the selling brokerage firm must deliver the security certificate the buying brokerage firm no later than three business days after the sale. After the brokerage firm, or an external clearing agency responsible for reconciling the transaction, receives the payment and securities, the payment and the securities are exchanged between the buyer and seller.

After a sale, but before a seller receives payment, the seller's securities are fled-up in the external settlement process. During this time period after a sale, but before the transaction is reconciled, although the seller has not received payment, the seller no longer has possession of the securities (and therefore can not treat the securities as an asset). As a result, while the payment and securities remain in escrow during the three-day settlement period, the seller is unable to use the proceeds of the sale to purchase new securities. Likewise, the buyer is unable to sell the recently purchased securities in the event the market price immediately changes. Accordingly, while this three-day settlement process prevents unlawful parties from selling shares they do not own or buying shares with money they do not have, this waiting period diminishes the liquidity of both the buyer's and seller's accounts. For this reason, many broker/dealers may float the funds or the securities to theft users while the transaction is awaiting settlement. This, however, exposes the broker/dealers to financial liability in the event the securities or finds are not received from the other party.

In this patent application, the terms “security,” “exchange,” and “broker/dealer trading system,” are used as defined above.

### BRIEF DESCRIPTION OF THE DRAWINGS

FIG. 1 is a diagram of an example network communication system between personal computers and a securities trading system.

FIG. 2 is a schematic diagram of an example securities trading system coupled to a network.

FIG. 3 is a schematic diagram of an example Account Manager application that may be functioning within the securities trading system of FIG. 2.

FIG. 4 is a schematic diagram of an example Stock Specialist application that may be functioning within the securities trading system of FIG. 2.

FIG. 5 is a schematic diagram of example transaction spooler applications that may be functioning within the securities trading system of FIG. 2.

FIG. 6 is a schematic diagram of an example Database Manager application that may be functioning within the securities trading system of FIG. 2.

FIG. 7 is a diagram of an example hardware implementation of a personal computer and/or a securities trading system.

FIGS. 8A-8D collectively form a flow diagram of a method of reconciling orders to buy securities utilizing the securities trading system of FIG. 2.

FIGS. 9A-9D collectively form a flow diagram of a method of reconciling orders to sell securities utilizing the securities trading system of FIG. 2.

### DETAILED DESCRIPTION

Although the following discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware, and/or software. Accordingly, while the following describes example systems, persons of ordinary skill in the art will readily appreciate that the examples are not the only way to implement such systems. Moreover, while the following example describes a securities trading system using the Internet, the methods and apparatus disclosed herein could utilize other computer networks.

System Overview

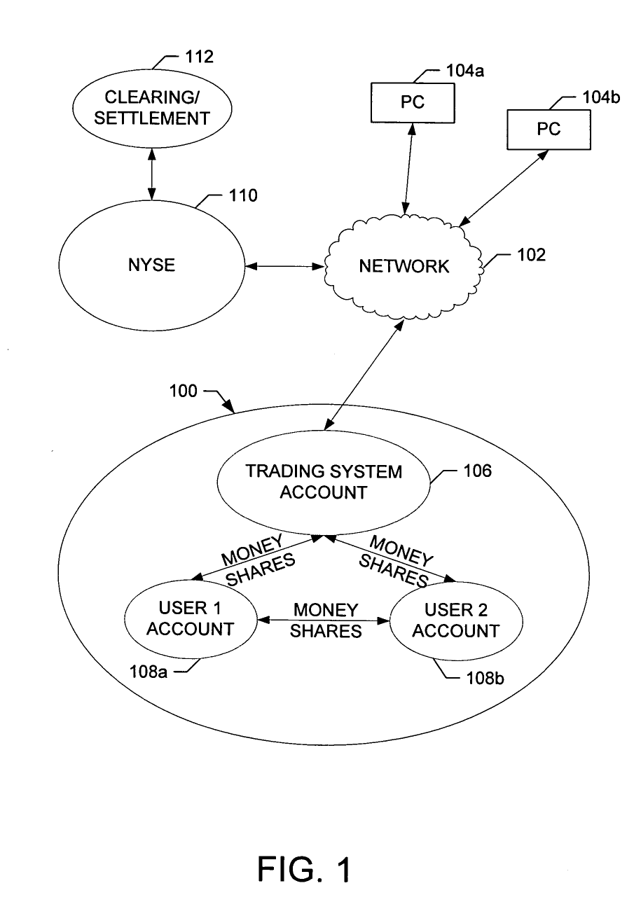

FIG. 1 is a diagram of an example network communication system between personal computers and a securities trading system. In one example, a securities trading system 100 may be coupled to a communication network 102 such as the Internet to which a plurality of personal computers 104a and 104b may also be connected. In the example of FIG. 1, the securities trading system 100 may be implemented using a computer, or series of computers. It is well known to those having ordinary skill in the art, however, that other computer networks may be used to connect a plurality of personal computers with a securities trading system.

In one example, the trading system 100 comprises a trading system account 106 and a-plurality of user accounts 108a and 108b. The trading system buys and sells securities with outside exchanges 110, such as the New York Stock Exchange, and stores these securities in the trading system account 106. In addition, the trading system 100 receives money from a plurality of users and stores this money, in the name of each user, in the trading system account 106. Alternatively, in another example, after receiving money from each user, the trading system 100 may store each user's money in one or more of the user accounts 108a and 108b within the trading system.

Each user account 108 comprises a record of the user's securities and cash account balance within the trading system 100. As discussed in further detail below, because every user's securities and money are held within and verified by the trading system 100, users may exchange securities and money instantaneously within the trading system 100 without the need for external settlement 112 and its attendant delays. The trading system 100 holds all the users' money and securities—organized according to each user in user accounts 108—so that a transaction between two users is a transfer of money and securities from one user account 108a on the trading system 100 to another user account 108b within the same trading system 100.

The trading system 100 validates the quantity and ownership of the securities and amount of money in each user's account 108 within the trading system 100 before allowing a transaction to commence. Because users do not exchange money or securities outside of the trading system 100, the trading system 100 knows that all securities and monies held within the trading system 100 are valid. Therefore, there is no need to wait for validation from an external settlement agency 112 to complete the transaction. This allows the transaction within the trading system 100 to occur instantaneously whereby the users participating in a transaction receive theft money or securities immediately.

As an interface to the trading system 100, the personal computers 104 connected to the network may display, on a browser running on each personal computer 104, information and data from the trading system 100. The information may be generated and displayed using, for example, hypertext markup language (HTML), JavaScript, Java Server Pages (JSP), or Servlets. In one example, many of the HTML programmed pages displayed by the browser to represent actions and status within the trading system 100 are dynamically constructed from template pages on a server before the pages are made available to the browser for display. One or more HTML pages may be embedded with JavaScript code that may perform data validations and processing externally from the trading system 100.

In addition, in one example, Java applets may provide an interface with users operating the personal computers 104. In one example, a single set of applet classes are loaded in a set of HTML frames. The applet instance in each frame is invoked with a different name, causing it to have a unique behavior, but because there is only a single set of applet classes, different applets can communicate and share data.

In one example, a single Java applet manages different frames within the web browser. The various responsibilities of the browser may include managing the account status displayed to the user; managing the securities watch list (where users can list securities and can initiate requests to view the order book and activate the trading floor for a given security; managing the security order book(s) displayed to the user); managing the securities trading floor where users enter new orders and modify or remove theft existing orders; and managing security performance data displayed to the user in the watch list, on the trading floor, in the stock tickers, and in the spy list.

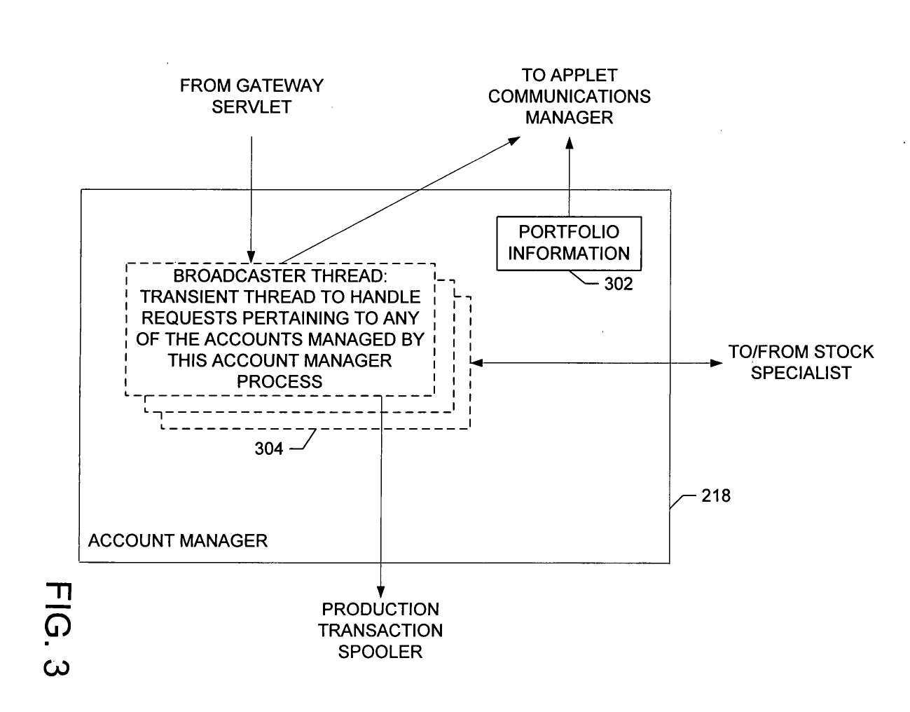

In another example, there is a Java user applet that functions to manage the user account 108, portfolio information 302 (FIG. 3), a list of holdings, and a spy list. The user applet may also handle initiating requests to activate a trading floor applet for a given stock, and for changing the active user account 108 and/or brokerage.

Another example Java applet is a trading floor applet that handles the display and management of a book for any stock on the trading floor. Each trading floor shows the book for that floor while the user is on the floor. In one example, the book lists the five highest bids and five lowest asks for the stock on the corresponding trading floor. The book display is updated in real-time thereby reflecting the most current bids and asks for the stock. The trading floor processes events related to the book including processing user requests to create, modify, or remove quotes on the stock and updating the book to reflect quote updates which have resulted from actions by other buyers or sellers for the stock.

Other examples of Java applets may include a ticker applet that processes a streaming feed of market quotes on stocks, and a market indicators applet that processes a streaming feed of market indicator data including composite and index values.

Securities Trading System Overview

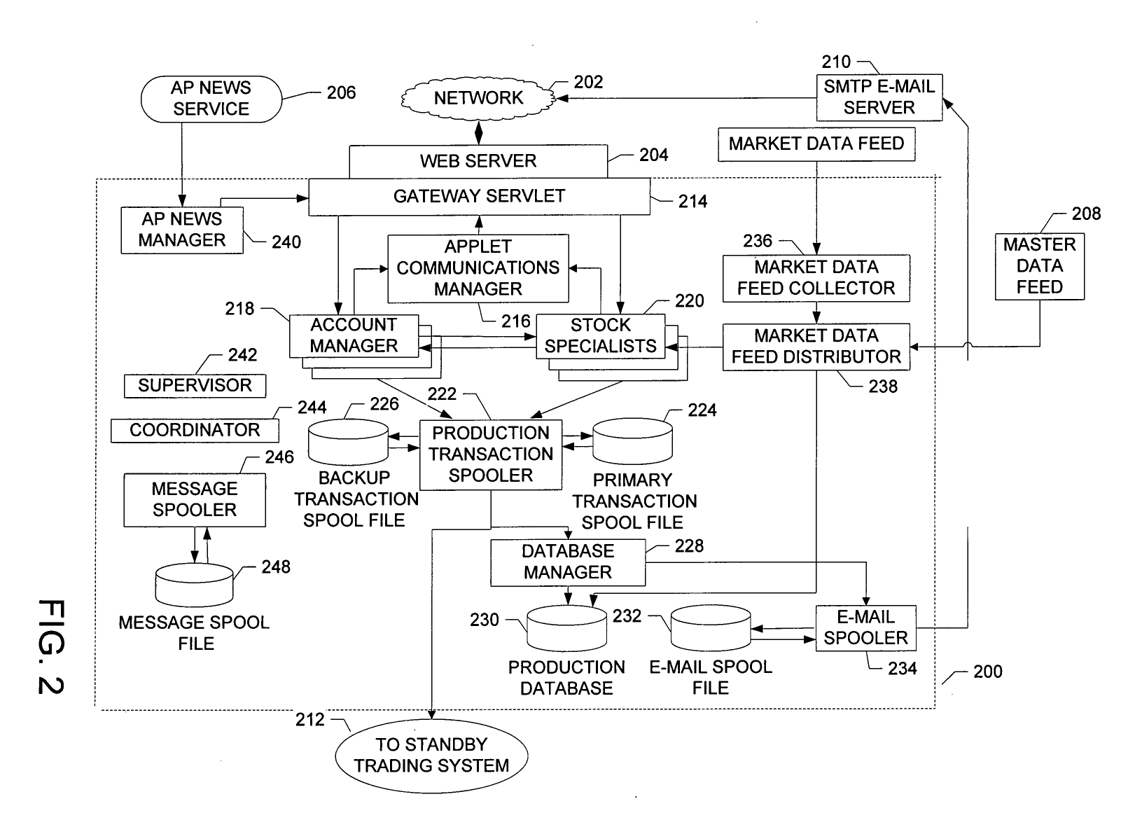

FIG. 2 is a schematic diagram of an example securities trading system 200. External to the system 200 (which may be used to implement the system 100 of FIG. 1) are one or more components that exchange information and data with the system 200 including a network 202 (reference number 102 in FIG. 1), a web server 204, one or more news services 206, one or more market data feed services 208, an e-mail server 210, and a standby system 212. Within the trading system 200 are a Gateway Servlet 214, a Communications Manager 216, one or more Account Managers 218, one or more Stock Specialists 220, a Production Transaction Spooler 222, Primary and Backup Transaction Spool Files 224 and 226, a Database Manager 228, a Production Database 230, an E-mail Spool File 232 and Spooler 234, a Market Data Feed Collector 236 and Distributor 238, a News Manager 240, Supervisor 242 and Coordinator 244 applications, a Message Spooler 246 and a Message Spool file 248.

The Gateway Servlet

In operation, the system 200 connects to a network 202 via the web server 204 connected to the gateway servlet 214. The gateway servlet 214 executes within the web server and is the conduit communicating requests, information, and data between the trading system 200 and the network 202. In one example, the gateway servlet 214 receives information from the AP news manager 240 and Communication Manager 216 which it in turn passes on to logged on users via the network. In addition, the Gateway Servlet receives requests from logged on users via the network which it passes on to the Account Managers 218 and Stock Specialists 220.

In one example, the Gateway Servlet 214 may be implemented using one or more gateway applets that execute as threads within the web server 204. New threads of execution of the gateway class are run by the web server 204 for each communication received from the personal computers, whereby multiple instances of the gateway class may be executing at any given time and terminate upon completion of the request.

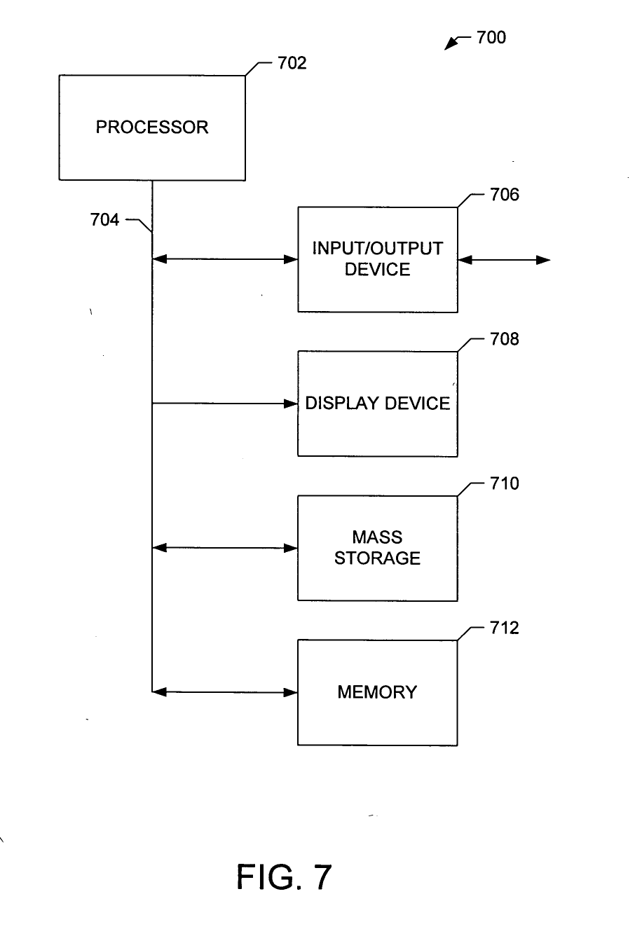

In one example, the Gateway Servlet 214 may be triggered by a personal computer (FIGS. 1 and 7) sending or requesting information from a uniform resource locator (URL). An example format of an IJRL in which the gateway applet is the target is: <IP Address>/server-java/Gateway/<request?param1=val&param2=val2>, where “IP Address” is the internet name or address of the server running the web server, “server-Java” is the static string required by the web server to indicate that the parameter is a Java class invoked as a server-side java component as the URL target, and “Gateway” is the name of the Java servlet class implemented by the trading system 200. In one example, the Gateway Servlet code resides in a gateway.class file in the Java applet directory configured for the web server 204. “Request” is the specific request to be processed by the Gateway Servlet 214, “param ” is the name of a parameter that is relevant to the specified request, and “val” is the value of the parameter. The general format of requests to the Gateway Servlet 214 consists of a string identifying the request, followed by a string of parameters, with each parameter delimited with a new-line character (/n). Any replies generated by the Gateway Servlet 214 will be in the same format.

In one example, once a user requests to log onto the trading system 200, the web server 204 launches a thread of the Gateway Servlet 214 to process the request. The Gateway Servlet 214 creates an RMI connection to the Coordinator 244 and requests the Coordinator 244 to process the request—which includes validating the user name and password. If the user is valid, the Gateway Servlet 214 will request the Coordinator 244 for RMI connections to the Account Manager 218 for the account, and the Stock Specialist 220 for those securities held in the user's account.

In one example, the Gateway Servlet 214 may get additional information from the personal computer (FIGS. 1 and 7) including the name of an .ini file that matches HTML aliases to actual filenames, the name of the directory containing HTML template files, the IP address of the gateway server host, an optional Gateway output location, a Message Spooler 246 IP address and port, or the name of a cabinet file in which the trading system's user applet class files are bundled for use with one or more web browsers. The IF address and port of any Account Manager 218 or Stock Specialist 220 applications with which the Gateway Servlet 214 communicates will be queried by the Gateway Servlet 214 from the Coordinator 244 as needed.

In one example, the Gateway Servlet 214 may also dynamically construct some of the HTML pages for display by web browsers running on the personal computers (FIGS. 1 and 7). If a HTML page contains a form, the Gateway Servlet 214 may also interpret the data sent back by the browser when a user completes the form. Specifically, the accent, or “tick,” character is used to delimit values in the HTML template file that will be substituted before the page is returned to the client. For example, <FORM action=https://‘gateway_host’/server-java/Gateway/logonData?br=‘br’>. where “gateway_host” is the address of the gateway host, “br” is die appropriate value. When the Gateway Servlet 214 must return an HTML page to the client, the Gateway Servlet 214 gets the actual name of the HTML file from the .ini file specified in the “html_file” parameter of the trading system 200. The Gateway Servlet 214 then reads the HTML file with the corresponding name from an “html_models” directory specified in an ini file. In addition, the HTML page may also be cached by the Gateway Servlet 214.

Once the Gateway Servlet 214 has the HTML page, it does a siring substitution that causes all tokens in the file, identified with the accent delimiter, to be replaced with the appropriate values from the Gateway Servlet 214 hash table of information.

The Communication Manager

Coupled to the Gateway Servlet 214 is a Communication Manager 216 (“CommManager”), which is used for most communications between the applets running on the personal computers (FIGS. 1 and 7) and the server-side Account Manager 218 and Stock Specialist 220 applications. The function of the CommManager 216 is to packetize and queue all data from the Account Managers 218 and Stock Specialists 220 for an intended recipient, until that recipient accepts and acknowledges the data.

There may be multiple CommManager 216 processes running within the trading system 200 in order to distribute the load. A logged-on user account will be managed by a single CommManager 216 at any one time, so all messages for that user are routed through the CommManager 216 assigned to that user account.

Each CommManager 216 registers itself with the Coordinator 244 as the manager for communications to each logged on user that the CommManager 216 is managing. This allows multiple Stock Specialists 220 and Account Managers 218, when sending data to different users, to query the Coordinator 244 through a single instance of the CommManager 216 that is responsible for sending data to each user.

In one example, to facilitate communication, MessageGrams are exchanged, via the CommManager in the form of datagrams, between either a Stock Specialist 220 or an Account Manager 218 and the Java applets. A MessageGram contains a version identifier, a stock identifier, and specific “grams” pertaining to the message (e.g., a BookGram, AccountGram, QuoteGram, or InfoGram). The recipient of a MessageGram causes the CommManager 216 to reply to the sender with an acknowledgement (“ack”) in the form of an AckGram, which contains the same version identifier as the MessageGram. If the recipient of the MessageGram is not interested in further communications from the sender, the recipient may reply with a negative acknowledgement (“nak”). A nak is simply an AckGram with a version identifier of-1. A client applet can also post an unsolicited nak to a server application as notification that no further MessageGrams on the specified item should be sent. For example, as described below, a user applet may send an unsolicited nak to an Account Manager 218 if the user signs off or the applet may send an unsolicited nak to a Stock Specialist 220 if the user has moved to a new trading floor.

In one example, datagrams may be used by the trading system 200 to send MessageGrams or AckGrams, which are replies to MessageGrams. Specifically, the CommManager 216 acts as an intermediary between applets and server applications as server applications may be running on a server different than the one that “served up” the client applet. The CommManager 216 accomplishes this by having an IF address set as the code base when loading client applets. The IP address of the client applet is set through the “codebase” directive in the HREF statement in the HTML file. In addition, the CommManager 216 functions to enable communications beyond a firewall by directing the client application to open a special CommManager TCP socket at port 9877. Communications that the server would normally send to the client via datagram will be written to this socket instead. The CommManager 216 will then forward replies to these communications on to the originator as a datagram.

In one example, various threads may run in the CommManager 216 that listen for datagram communications between client and server applications, forward datagrams to intended applets or servers, and listen for TCP socket communications between server applications and client applets. The CommManager 216 also starts a receiver thread that reads and forwards MessageGrams from the server socket and listens for TCP socket communications on, for example, port 9877 from a client applet to a server application.

The Account Manager(s)

One or more Account Managers 218 receive information and data from the Gateway Servlet 214 and send information and data to the CommManager 216 (FIGS. 2 and 3). In addition, the Account Managers 218 may exchange information with the Stock Specialists 220 and send data to the Production Transaction Spooler 222.

The Account Manager application 218 manages and handles a set number of users that are currently signed-on to the trading system 200. In one example, the Account Manager 218 is responsible for ensuring that a user book displays an accurate list of all outstanding quotes (bids if the user is a buyer, asks if the user is a seller) and completed sales for each user. Each application of an Account Manager 218 keeps a running total of an individual user's account balance and securities portfolio and launches an account thread for each user (FIG. 3). The Account Manager 218 application has a dedicated, synchronized thread for each user account that the Account Manager 218 is managing. This thread maintains the current user account detail in memory, including cash balance and security holdings. Once transactions occur that affect a user's account (e.g., a trade execute), the Account Manager thread managing that user account will, after spooling a transaction to record the event in the database (as described below), update the cash balance and holdings as appropriate in memory. Because each Account Manager thread is synchronized, only a single transaction which affects a given account can be processed at any point in time. This implementation enables the trading system to ensure that a user account has adequate cash and/or holdings to conduct a requested transaction. In addition, each Account Manager 218 knows the status of each user account. For example, each Account Manager 218 is aware if a user's account has been suspended, approved for trading, etc.

There may be multiple Account Manager 218 processes running within the trading system 200 in order to distribute the load. A logged on user account will be managed by a single Account Manager 218 at any onetime, so all requests and transactions which pertain to that user account are routed through the Account Manager 218 assigned to that user account.

Each Account Manager 218 registers itself with the Coordinator 244 as the manager for each of the user accounts that the Account Manager 218 is managing. This allows the Gateway Servlet 214 to query the Coordinator 244 in order to direct any requests pertaining to a given user account to the one and only Account Manager 218 responsible for that user account.

In one example, there may be a broadcaster thread that runs at a low priority and is responsible for notifying user applets of changes to the user book. These notifications may be made by posting a MessageGram (type InfoGram) on a datagram socket to the user applet via the CommManager 216. The user applet will post back an acknowledgement (“ack”) datagram, also via the CommManager 216.

In one example, each broadcaster thread may maintain a UserList that contains the user's account number and the IP address and port to which quote change notifications are to be sent. The IP address and port specified are that of the user applet application. The CommManager 216 forwards (or broadcasts) notification events to the user applet. When the broadcaster thread starts, it creates a datagram socket and then launches an AckReceiver thread against that socket. The AckReceiver thread is responsible for receiving acknowledgements for quote change notifications sent out by the broadcaster thread. Acknowledgements are received as datagrams containing an AckGram. When the AckReceiver thread receives an AckGram, it passes it off to the broadcaster thread to process. The AckReceiver may also receive a “nak” (either in reply to a MessageGram from the Broadcaster thread or unsolicited) from the User applet. The “nak” is also passed of to the broadcaster thread for processing, which may be cleanup action.

The Stock Specialist(s)

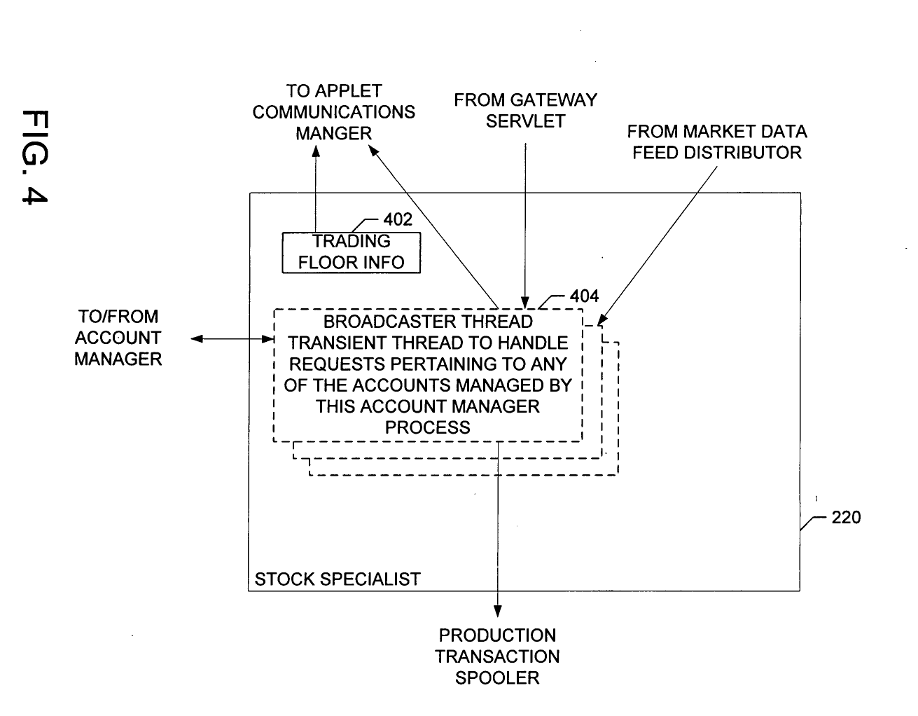

One or more Stock Specialists 220 receive information and data from the Gateway Servlet 214 and send information and data to the CommManager 216 (FIGS. 2 and 4). The Stock Specialists 220 may also exchange information with the Account Managers 218, send data to the Production Transaction Spooler 222, and receive information from the Market Data Feed Distributor 238.

The Stock Specialist 220 manages securities. In one example, each Stock Specialist 220 is responsible for managing an assigned group of securities. The management of a security or group of securities includes processing quote additions or changes for a stock, tracking market pricing for securities provided from an external provider, tracking users who are at the trading floors viewing a virtual book listing current quotes (bids and asks), and notifying all users on trading floors of quote changes made by other users by broadcasting notification events to all personal computer applets associated with those users on trading floors.

The Stock Specialist 220 has a dedicated, synchronized thread for each security which it is managing. This thread maintains the security detail in memory, including the order book, market prices, and list of users viewing the book. As transactions occur which affect a security, such as requests to buy shares, the Stock Specialist thread managing that user account will, after spooling a transaction to record the event in the database (as described below), update the order book in memory. Because each Stock Specialist thread is synchronized, only a single transaction which affects a given security can be processed at any point in time. This implementation enables the trading system 200 to ensure, for example, that a sell order has acceptable price and quantity to fill a buy order.

There may be multiple Stock Specialist 220 processes running within the trading system 200 in order to distribute the load. A security will be managed by a single Stock Specialist 220 at any one lime, so all requests and transactions which pertain to that security are routed through the Stock Specialists 220 assigned to that security.

Each Stock Specialist 220 registers itself with the Coordinator 244 as the manager for each of the securities that the Stock Specialist 220 is managing. This allows the Gateway Servlet 214 to query the Coordinator 244 in order to direct any requests pertaining to a given security to the one and only Stock Specialist 220 responsible for that security.

In one example, a Stock Specialist run-line argument may contain the name of the group whose stocks will be managed by each instance of the Stock Specialist 220. The group name corresponds to the name of each active security. On startup, the Stock Specialist 220 opens an anonymous ServerSocket to receive requests whereby the system will assign an available port for the socket. The Stock Specialist 220 then connects to the Production Transaction Spooler 222, which is running on the same machine as the Stock Specialist 220, and connects to the Database Manager 228 via DataBaseConnection class, specifing the user name “specialist.” The Stock Specialist 220 obtains the list of stocks belonging to the group being managed by the Stock Specialist 220. Each stock is registered with the Coordinator 244, specifying the Committee on Uniform Security Identification Procedures (CUSIP) number (a nine digit number serving to uniformly identify the security) and the IP address and port of the Stock Specialist application 220. The Stock Specialist 220 then launches a broadcaster thread for each stock managed by the Stock Specialist 220 (FIG. 4).

In one example, there may be a broadcaster thread that runs at a low priority and is responsible for notifying applets of a stock's quote changes. These notifications are made by posting a MessageGram (type InfoGram) to the client applet via the CommManager 216. The applet will post back an acknowledgement (“ack”) via the CommManager 216. When the broadcaster thread starts it creates a datagram socket and launches an AckReceiver thread against that socket. The AckReceiver thread is responsible for receiving acknowledgements for quote change notifications sent out by the broadcaster thread. Acknowledgements are received as datagrams containing an AckGram. When the AckReceiver thread receives an AckGram, it passes the AckGram off to the Broadcaster thread to process. The AckReceiver may also receive a “nak” from the applet (either in reply to a MessageGram from the broadcaster thread or unsolicited). The “nak” is also passed of to the broadcaster thread for processing, which may be cleanup action on the stock or user.

The Stock Specialist 220 provides a user interface for system administration functions. This interface provides the ability to add or remove securities from the list of those being managed by this instance of the Stock Specialist 220 (although not from the Database Manager 228), and to get a list of users (buyers and sellers) for the stock and a list of users currently on the trading floor for a stock.

The Account Managers 218 and Stock Specialists 220 maintain and update the users' account and securities data in memory and do not rely on the Production Database 230 to verify users' account holdings and securities information—i.e., the users' ability to place buy and sell orders. As described in more detail below, the Production Database 230 is used for archival purposes and is not used in the order placement, management, and matching functions of the trading system 200.

The Transaction Spooler(s)

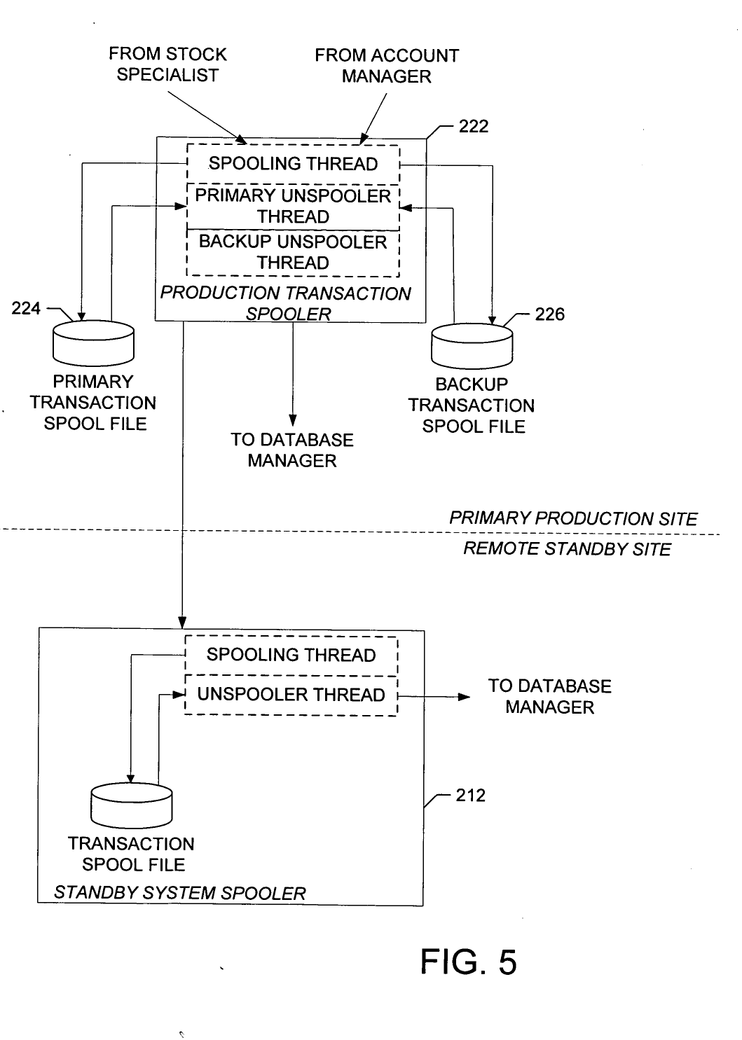

The Production Transaction Spooler 222 (FIGS. 2 and 5) receives information from the Account Managers 218 and Stock Specialists 220. The log file provides a recovery mechanism in the event of a problem with the Production Database 230. In one example, the Production Transaction Spooler 222, along with the Primary and Backup transaction spool files 224 and 226, provides a mechanism for tracking and synchronizing stock and user transactions on the trading system 200. All stock and user database transactions from Stock Specialist 220 or Account Manager 218 applications are processed and logged by the Production Transaction Spooler 222 and the Primary and Backup Transaction Spool Files 224, and 226. Records from the spool files are unspooled in an orderly fashion and written to the Production Database 230 via the Database Manager 228.

In this example, after receiving transaction information from the Stock Specialists 220 and Account Managers 218, the Production Transaction Spooler 222 simultaneously writes the transaction to both the Primary and Backup Transaction Spool Files 224 and 226 (FIG. 5), and then replies with success to the Stock Specialist 220 or Account Manager 218. This enables the Stock Specialist 220 or Account Manager 218 to, in turn, complete the transaction and continue on to immediately process the next request. After unspooling transactions from the Primary Transaction Spool File 224, the Production Transaction Spooler 222 sends these transactions to the Database Manager 228 for entry into the Production Database 230 and to the E-mail Spooler 234. Likewise, the Production Transaction Spooler 222 unspools transactions from the Backup Transaction Spool File 226 and may send these transactions to a standby system 212 externally located from the trading system 200.

The standby system 212 may contain a standby transaction spool file that may unspool transactions to the Database Manager 228 or on a database manager on the standby system 212. This ensures that the standby database will be synchronized with the Production Database 230 in the event the trading system 200 needs to recover data, or operations need to be relocated. It is well known to those having ordinary skill in the art, however, that other transaction spooler methods may be used to receive transactions from the Account Managers and/or Stock Specialists prior to writing to a database. Specifically, a single transaction spooler may be used or, alternatively, no transaction spooler may be used with transactions writing directly from the Account Managers and Stock Specialists to the Database Manager.

In one example, the Production Transaction Spooler 222 may also obtain the IP address of the Database Manager 228 from the .ini file specified in the registry file of the web server 204. The Production Transaction Spooler 222 starts its unspooler thread that will open the spooler file whose name was specified on the run-line. The file is opened for input and output (read/write) access. Initial control data (which is a record offset value) is written to the beginning of the file each time it is opened. The unspooler thread will get the transaction sequence number of the last transaction that was successfully unspooled from the Production Transaction Spooler 222 to the Production Database 230, and the unspooler thread will proceed to unspool and write to the Database Manager 228 any transactions that are in the Production Transaction Spooler 222 but haven't been written to the Database Manager 228. The unspooler thread will then loop unspooling records, read records from the spooler file whenever a new one is written to the file (via the SpoolCollector thread), and process these records by writing the record to the Database Manager 228. If the Production Transaction Spooler 222 has a problem writing to the Database Manager 228, the Production Transaction Spooler 222 will attempt to close and reopen the Database Manager 228.

In one example, the unspooler thread will periodically write a control data record to the Primary and Backup Transaction Spool Files 224 and 226. The unspooler class serializes I/O to the Primary and Backup Transaction Spool Files 224 and 226. It provides a public write function that both the spool collector thread and unspooler thread use to write to the Primary and Backup Transaction Spool Files 224 and 226. In one example, the Primary and Backup Transaction Spool Files 224 and 226 never get smaller, they only get successively larger. The Primary and Backup Transaction Spool Files 224 and 226 may be manually deleted or renamed to start a new spooler file.

In one example, once the unspooler has been successfully initialized, the spooler thread will then loop waiting for input. When the spooler thread gets input it starts an instance of the SpoolCollector thread. There may be multiple SpoolCollector threads executing at any time. The SpoolCollector thread will loop, thereby obtaining the input data by reading data from the socket stream, if necessary. In one example, each transaction record in the input stream is terminated with a new-line character. Each record read by the SpoolCollector is then written to the spooler file as a transaction record. A transaction record contains the address of the spooler process, a transaction sequence number (which is bumped for each transaction), and the record data as a comma-delimited ASCII string. The write to the Primary and Backup Transaction Spool Files 224 and 226 is carried out through a call to a synchronized member function in the unspooler thread.

The Database Manager(s)

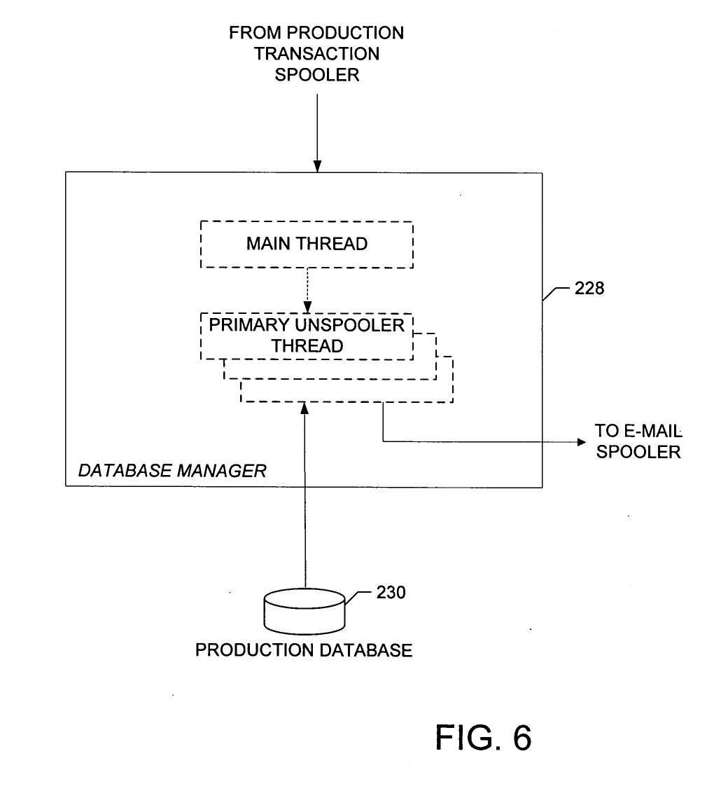

The Database Manager 228 receives information from the Production Transaction Spooler 222 (FIGS. 2 and 6). The Database Manager 228 writes information to the Production Database 230 and sends an e-mail notification to the user via an E-mail Spooler 234 if necessary.

In one example, the Database Manager 228 processes all transaction records from the Production Transaction Spooler 222 and inserts or updates the appropriate records in the Production Database 230 in order to record the transaction. In one example, for a trade execution, the Database Manager 228 receives a “trade execute” transaction from the Production Transaction Spooler 222 and then inserts a record to the trade blotter table; updates the ledger table such that the appropriate funds are transferred from the buyer account to the seller account; updates the ledger table such that any transaction fees are deducted from the buyer and seller accounts; and updates the holdings table such that the shares are transferred from the seller's account to the buyer's account.

The Production Database 230 serves as an archive of all transactions occurring within the trading system 200. Whereby the Account Managers 218 and Stock Specialists 220 maintain and update the users' account and securities data in memory, the Production Database 230 is not used in the order placement, management, and matching functions of the trading system 200. The Database Manager 228 writes transactions to the Production Database 230 for backup and record keeping purposes.

In one example, the Database Manager 228 receives a single run-line parameter: the port ID on which it must take requests. On initialization, the Database Manager 228 obtains the name of the .ini configuration file from the registry of the web server 204. The Database Manager 228 retrieves the IP address and port of the Coordinator 244 and registers itself with the Supervisor 242.

In one example, the Database Manager 228 may await incoming connections and when an incoming connection is received, the Database Manager 228 launches a DataCollector thread to handle the transactions written to that connection (FIG. 6). There may be multiple DataCollector threads running at any time. The DataCollector thread unspools the transaction from the input stream and writes the unspooled transactions to the Production Database 230 via the trading system DataBaseConnection utility classes. The DataCollector thread then processes the transaction by inserting or updating the appropriate records in the Production Database 230. Finally, the DataCollector formats an e-mail notification message to the user, if required, and writes to the E-mail Spooler 234.

The Message Spooler 246 receives information from all components in the trading system 200. There is only a single instance of the Message Spooler application 246 running. All other applications will look up the IP address and port of the Message Spooler 246 in the .ini file, and will direct their message output to this application. To record the messages and data transferred within the system 200, the Message Spooler 246 sends data to a Message Spool File 248.

In one example, the Message Spooler 246 provides a mechanism to log any message to a Message Spool File 248 and to a user interface window to provide a mechanism for troubleshooting the trading system 200. The window and/or log output are to be monitored regularly by a trading system administrator. Messages can be of any type such as, for example, informational, status, warning, error, etc. The Message Spooler 246 does not perform any special processing based on message type.

The Message Spooler application 246 runs as an instance of the spooler classes, as do the Production Transaction Spooler 222 and E-mail Spooler 234. One of the primary differences between the Production Transaction Spooler 222 and the Message Spooler 246 is that the Message Spooler 246 writes records to its output window as it unspools them, rather than writing the records to the Database Manager 228 as done by the Production Transaction Spooler 222.

The output from the Message Spooler 246 is simply a listing of all events logged to the Message Spooler 246 by other trading system server processes. The date and time at which the message was logged are also recorded in the spool file. In one example, the most recent messages or logs are written to the bottom of the log file or list and older messages are scrolled off the top of the list. The system administrator can clear the message log at any point. Clearing the log does not suspend logging, it merely clears existing log entries from the window. Additionally, clearing the log will not clear the Message Spool File 248 because to eliminate the Message Spool File 248, the Message Spool File 248 must actually be deleted or renamed. If the Message Spooler 246 application terminates, it can be restarted through the Supervisor 242 user interface.

The E-mail Spooler

The E-mail Spooler 234 receives information from the Database Manager 228. In one example, the E-mail Spooler 234 exchanges information with the E-mail spool file 232 and sends information to an E-mail server 210. The E-mail Spooler 234 provides a mechanism to spool outgoing programmatically generated e-mail messages. Like the Production Transaction Spooler 222 and Message Spooler 246, the E-mail Spooler 234 runs as an instance of the spooler classes. One of the primary differences between the Production Transaction Spooler 222 and the E-mail Spooler 234 is that the E-mail Spooler 234 writes the record as an e-mail message, rather than writing to the Database Manager 228 as done by the Production Transaction Spooler 222, or to a window as done by the Message Spooler 246.

The trading system e-mail tool class is used to write the e-mail. The e-mail tool class can be passed a string, or an e-mail template source file name. E-mail template source files are located in the e-mail_directory specified in the .ini file. Accent (tick) characters in the template source may be used to delimit values in the template file for substitution by the e-mail tool class at run-time. The E-mail Spooler sends information to a simple mail transfer protocol (SMTP) e-mail server outside of the trading system 200 for distribution to the intended recipients via the network 202.

The Supervisor(s)

The Supervisor application 242 is responsible for starting all applications within the trading system 200, and for monitoring these applications for failure. If any application started by the Supervisor 242 should fail, then the Supervisor 242 will start the application again. In the event that a system administrator wishes to stop or start any application within the trading system 200, these requests are processed by the Supervisor 242.

In one example, the Supervisor 242 may start, stop, monitor, and manage configuration of all other trading system server applications. The Supervisor 242 may provide a graphical user interface, which may be implemented using Java, for a system administrator to administer trading system server applications. In one example, there may be multiple instances of the Supervisor 242 running. One of the primary purposes of the Supervisor 242 is to start and stop server processes, so a Supervisor 242 may advantageously be run on each of the server machines that will run any trading system 200 server applications.

In one example, on startup the Supervisor 242 may read its configuration file containing the list of trading system server applications to be managed, start the applications specified in the configuration file, and create a window. The Supervisor 242 may initialize the window with the data from the configuration file. The window may contain a list of all server applications managed by that Supervisor 242, along with the status of the server applications. The main Supervisor thread waits for user input in the window. In terms of user input, the system administrator can stop selected applications, stop all applications, start selected applications, start all applications, add a configuration entry for a new server application, remove the configuration for a server application, and/or modify an applications configuration entry.

In one example, the Supervisor 242 may launch an “App” class thread to launch an application. When the application has been successfully launched, the thread notifies the main Supervisor thread that the application status should be updated to “started.” A pair of “WatchOutput” threads are then launched by the App thread to monitor and log events on the application InputStream and ErrorStream. The App thread then waits until the server application terminates, at which time it notifies the main thread that the application status should be updated to “Stopped,” stops the WatchOutput threads, and the App thread terminates itself.

In one example, the Supervisor 242 may listen to a ServerSocket at port 9984. The same Supervisor requests that can be generated by the user selecting a function in the window can be also be routed programmatically to the Supervisor 242 though this ServerSocket. The request utility application provides a general mechanism for performing this functionality. In addition, a “notify” request can be routed programmatically to the Supervisor 242 through the ServerSocket, although there is no corresponding Supervisor user interface for making a “notify” request. A “notify” request is a mechanism for notifying all trading system server applications managed by a given Supervisor 242 of some event.

In one example, the following functions pertaining to the server applications being managed by the Supervisor 242 may be supported by the Supervisor 242 upon receiving the request (if there are multiple Supervisor 242 processes running then the same requests should be sent to them if necessary). The Supervisor window displays a list of all applications being managed by that Supervisor 242, and the status of those applications. An application may be in one of the following states: stopped (indicates that the application is not currently running); started (indicates that the application is currently running); disabled (indicates that the application is currently disabled and may not be run until it is enabled by the system administrator); stopping (indicates that the application is in the process of stopping). For each application, the Supervisor window displays the configuration entry for that application. The configuration data includes: an application name by which the Supervisor 242 and other applications will be able to reference the application; a directory in which the class file for the application can be found; the name of the Java class file to run for the application; and any run line parameters which should be passed to the application when it is run by the Supervisor 242. There is also a “disable” checkbox that allows the application status to be changed from enabled to disabled and vice-versa. A disabled application cannot be started.

In one example, the following functions may be available in the Supervisor window: an add function enabling the system administrator to add a new application to be managed by the Supervisor 242; a save function that saves any changes made to the configuration for a new or existing application (which will be remembered whenever the Supervisor 242 runs); a remove function that deletes the currently active application from the list of applications which the Supervisor 242 manages; a start function causing the Supervisor 242 to run the currently selected server application if it is not already running; a stop function causing the Supervisor 242 to stop the currently selected server application; a start all function causing the Supervisor 242 to start all server applications that are not already running; and a stop all function causing the Supervisor 242 to stop all running server applications.

In one example, any output messages from the Supervisor 242 or its components may be displayed in the message list in the Supervisor window. Normally most of applications started by the Supervisor 242 will redirect their output to the Message Spooler 246, but if the Message Spooler 246 cannot be opened then output will be directed to the Supervisor window. The list can be cleared at any point by selecting the “clear” button.

In one example, the Supervisor 242 may support the following requests: a register function allowing an application to register the socket at which it can receive notification events (the application name registered must match one known to the Supervisor 242); a start function causing the specified application to start; a stop function causing the specified application to be stopped; a start all function causing all applications managed by the Supervisor 242 to be started; a stop all function causing all applications managed by the Supervisor 242 to be stopped; and a notify function causing the specified notification message to be written to all server applications on the socket registered for the application.

The Coordinator Application

The Coordinator application 244 receives requests from the Account Managers 218 and Stock Specialists 220. In one example, the Coordinator 244 tracks of all users logged-on to the trading system 200, all active securities, all Account Manager 218 and CommManager 216 applications that are currently running, and which securities, accounts, or users each is managing. There will only be a single instance of the Coordinator 244 running for the entire trading system 200. Requestors get the IP address and port of the Coordinator 244 from the trading system configuration file.

In one example, on startup the Coordinator 244 may get the name of its configuration file (.ini) from the registry and gets the following information from the configuration file: the port that the Coordinator 244 should be using; an optional Coordinator output location; the IP address and port of the Message Spooler 246; and the gateway host name (e.g., http://www.trading system.com). The Coordinator 244 then does the following initialization:sends a reloadConfig request to the Gateway Servlet 214 (port 80 at the gateway host name specified in configuration), informing the Gateway Servlet 214 that the Coordinator 244 has been started or restarted; opens specified Coordinator output, if any, or a Message Spooler 246 if none specified; initializes a cryptography library; initializes a Database Manager 228 connection; and specifies “Coordinator” as the user and “trading system” as the password. The database connection class then establishes the connection to the default database server, as specified in the ini configuration file, using the specified name and password.

In one example, the Coordinator 244 may then launch a thread to create, initialize, and manage the Coordinator window. This thread will create the window and then register the Coordinator 244 with the Supervisor 242 (via the Supervisor Events class). The thread then loops, checking occasionally to see if there are any expired users to be cleaned up. Expired users are ones that have been “deregistered” by the Account Manager 218, but may still be stored by the Coordinator 244 in the event that the Account Manager 218 will activate the user again in the short-term. Any deregistered user records that are maintained by the Coordinator 244 expire after a period of time, at which point they are cleaned up by this thread when it wakes up. The main Coordinator thread loops waiting for socket connections on the port created during initialization. Whenever a request is received, a new Coordinator thread is launched to process the request.

In one example, the Coordinator window may display the following lists: all users (buyers and sellers) registered with the Coordinator 244; all securities registered with the Coordinator 244; and all CommManager 216 and Account Manager 218 applications registered with the Coordinator 244. There is also a “detail” field that displays detailed information about the selected item from the users, stocks, or managers list.

The Market Data Feed Application

A Market Data Feed Collector 236 receives securities and market information from an external Market Data Feed Source 208. In one example, this Market Data Feed Source 208 may be a satellite transmission containing current securities and market index data. In another example (not shown), the Market Data Feed Collector 236 may receive securities and/or market information from the network 202. Upon receipt, the Market Data Feed Collector 236 sends securities and market information to a Market Data Feed Distributor 238 for transmission to one or more Stock Specialists 220 and the Production Database 230. The Market Data Deed Distributor 238 continuously sends securities and market information to the Stock Specialists 220. In one example, the Stock Specialist 220 corresponding to a particular security or group of securities will receive only information relating to that security or group from the Market Data Feed Distributor 238. In another example, the Market Data Feed Distributor 238 may send its information to the Stock Specialists 220 via the Gateway Servlet 214. In addition, the Market Data Feed Distributor 238 periodically sends security and market data information to the Production Database 230 for future reference in case this information is needed.

The News Manager Application

An AP News Manager 240 receives news information from an external AP news service 206. The AP News Manager 240 may receive this information directly (e.g., via satellite, etc.) or via the network 202. The AP News Manager 240 sends this information to the Gateway Servlet 214 for transmission to the Account Managers 218 and/or Stock Specialists 220. Alternatively, in one example, the AP News Manager 240 may send the news information directly to an individual, or a group of Account Managers 218 and/or Stock Specialists 220.

Hardware Description

FIG. 7 is a diagram of example hardware on which the above described systems may be implemented. For example, the hardware of FIG. 7 may be combined with software to operate the personal computer and/or a securities trading system. The trading system 200 of FIG. 2 may be implemented using a computing device 700, including, for example, a processor 702. The processor 702 is coupled to an interface, such as a bus 704 to which other components may be interfaced. In the illustrated example, the components interfaced to the bus 704 include an input/output device 706, display device 708, mass storage unit 710, and memory 712 which may be separate components or, alternatively, housed together in a single unit.

The computing device 700 may be, for example, a conventional desktop personal computer, a notebook computer, a server, a workstation, a mainframe, or any other computing device. In such a device, the processor 702 may be of any type of processing unit, such a microprocessor from the Intel® Pentium® family of microprocessors. The memory 712 that is coupled to the processor 702 may be any suitable memory device and may be sized to fit the storage demands of the computer 700.

The input/output device 704 may be implemented using a keyboard, a mouse, a touch screen, a track pad, or any other device that enables a user to provide information to the processor 702. Output may be implemented via, for example, COM, I/O, ethernet, modem ports, etc. and may be connected to other machines and networks that can interpret data from the processor 702. Other example output devices include, but are not limited to, printers, modems, networked computers, speakers, fax machines, copiers, etc.

The display device 708 may be, for example, a liquid crystal display (LCD) monitor, a cathode ray tube (CRT) monitor, or any other suitable device that acts as an interface between the processor 702 and a user. In addition, the display device 708 may be the same device as the input/output device 704, such as a touch screen monitor.

The mass storage device 710 may be, for example, a conventional hard drive or any other magnetic or optical media that is readable by the processor 702. The mass storage device 710 may store instructions or soil-ware that when executed implements the above-described system.

Other additions or examples of the computing device 700 may include a removable storage device drive such as a compact disk, digital versatile disk, floppy disk, magnetic storage tape, etc. Moreover, additional or alternative memory components may be used such as random access memory, flash memory, read only memory, and the like. Other additions or modifications to the general structure of the system will be readily apparent to those ordinarily skilled in the art.

In operation, the processor 702 reads instructions from one or more Gateway Servlets connected to the web server. In addition, the processor 702 may send and receive information, via an input/output device 706, from external data sources including, but not limited to, an AP news service, a market data feed satellite, an external standby system, and SMTP e-mail server as described in detail with respect to FIG. 2. It will be understood, however, that one or more of these processes may be carried out by different processor systems using one or more servers.

Buy Order Reconciliation

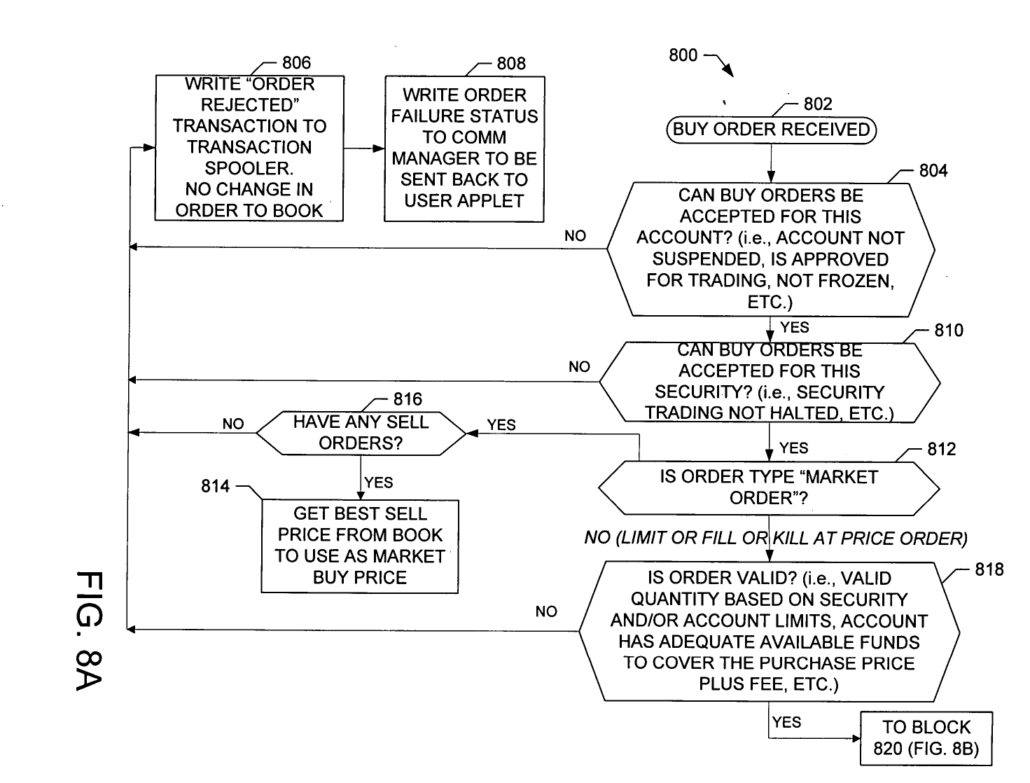

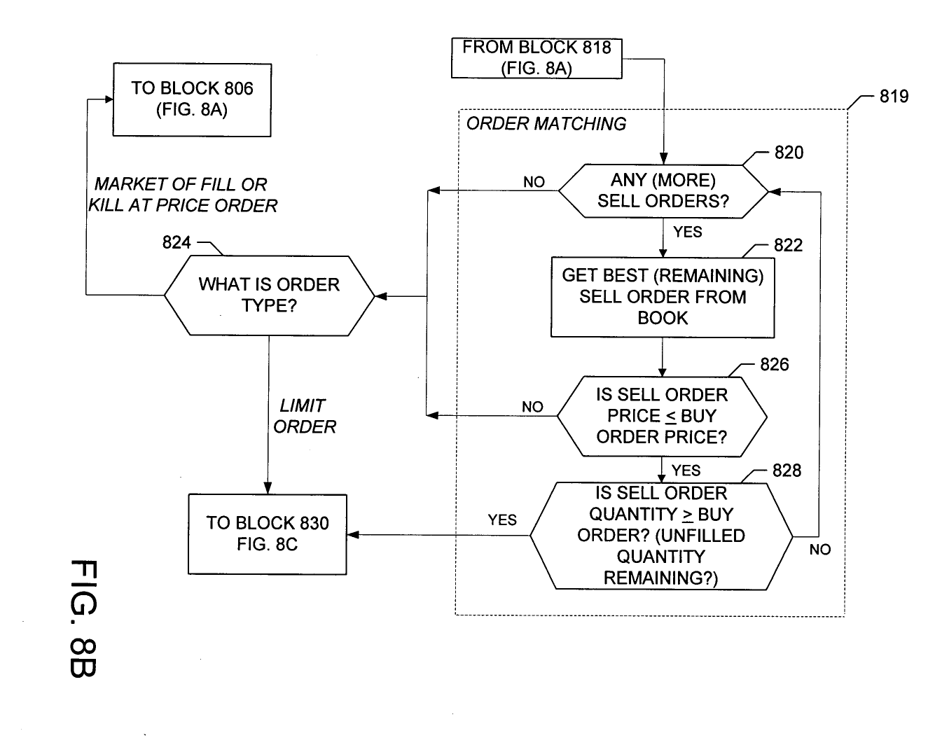

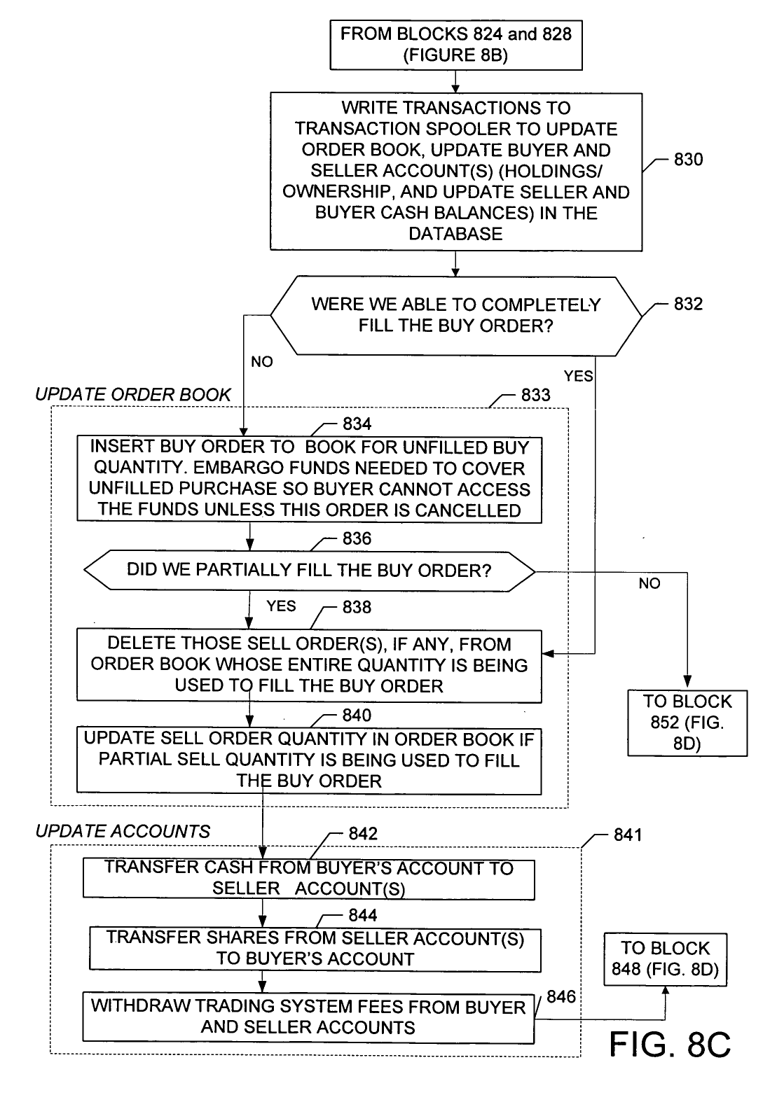

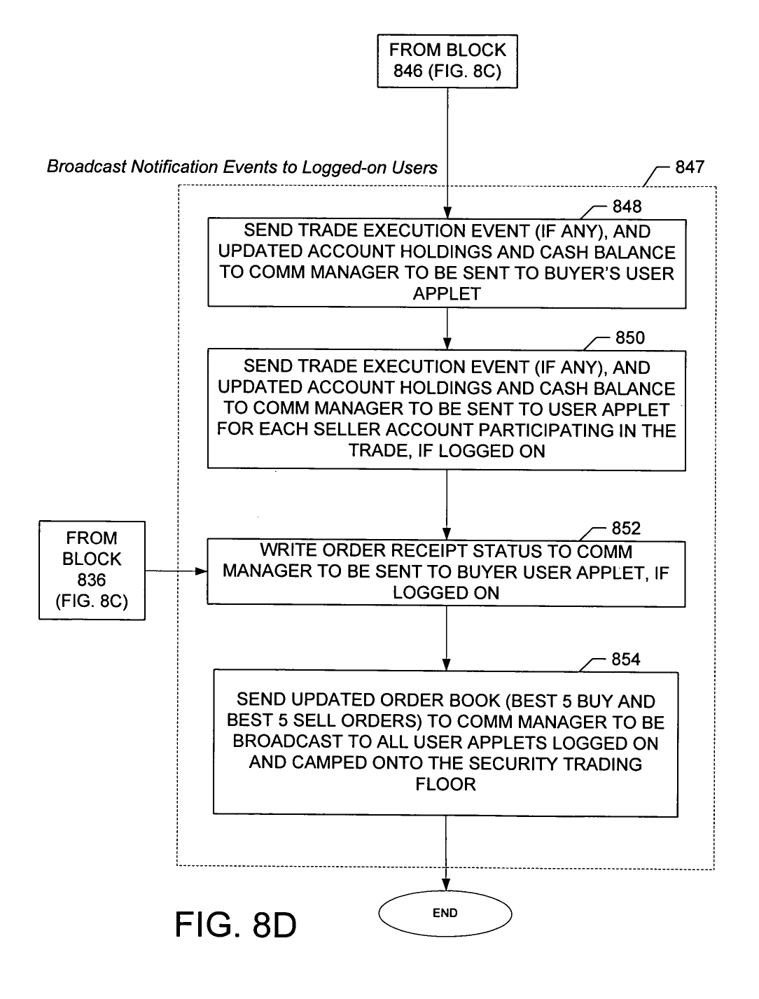

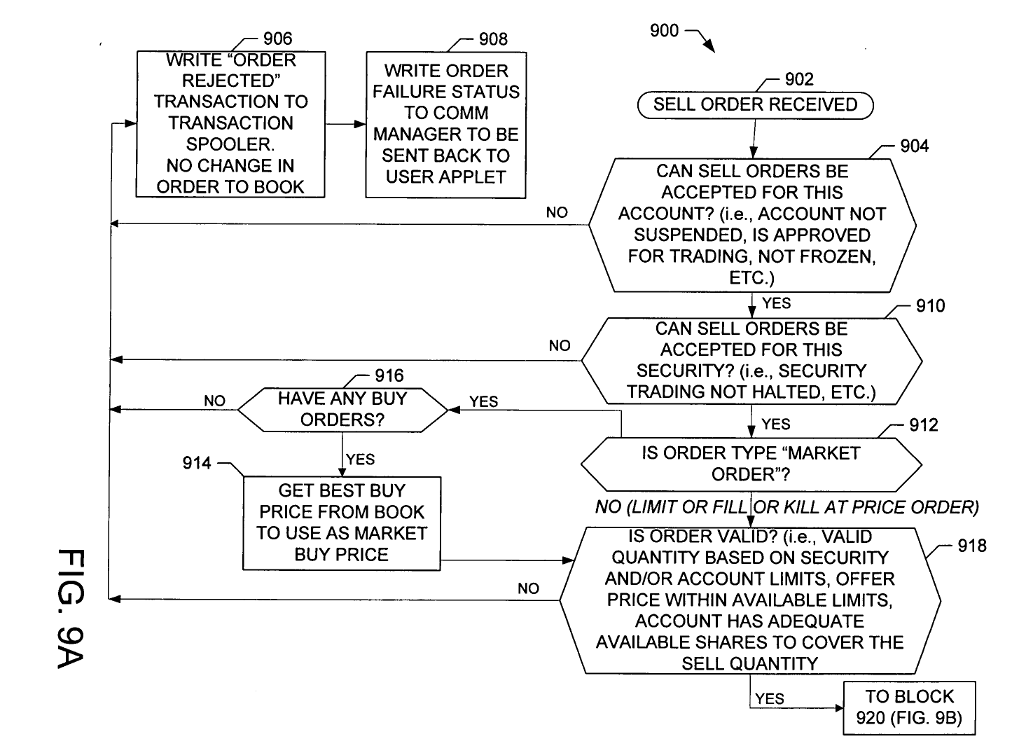

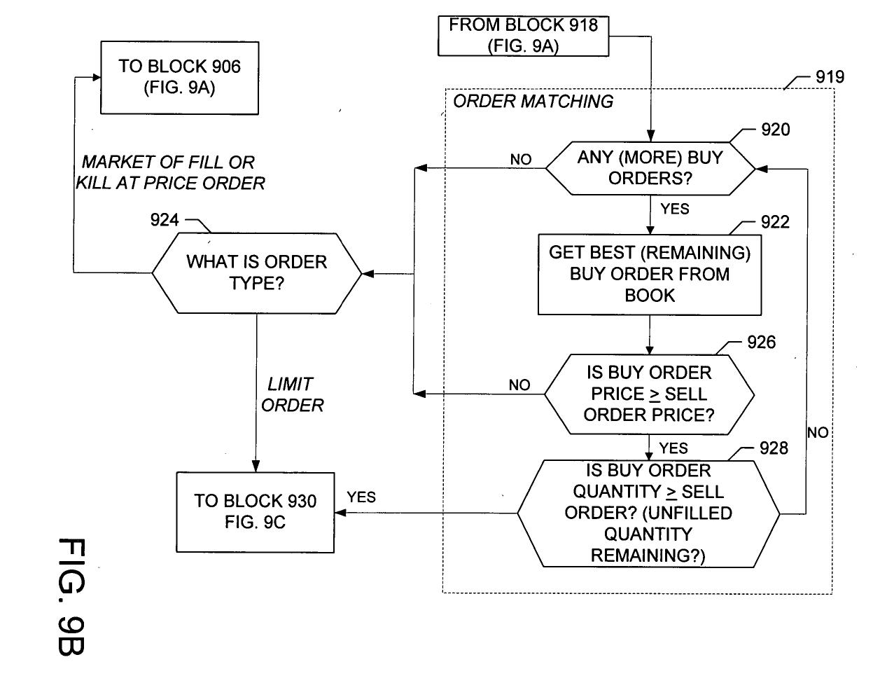

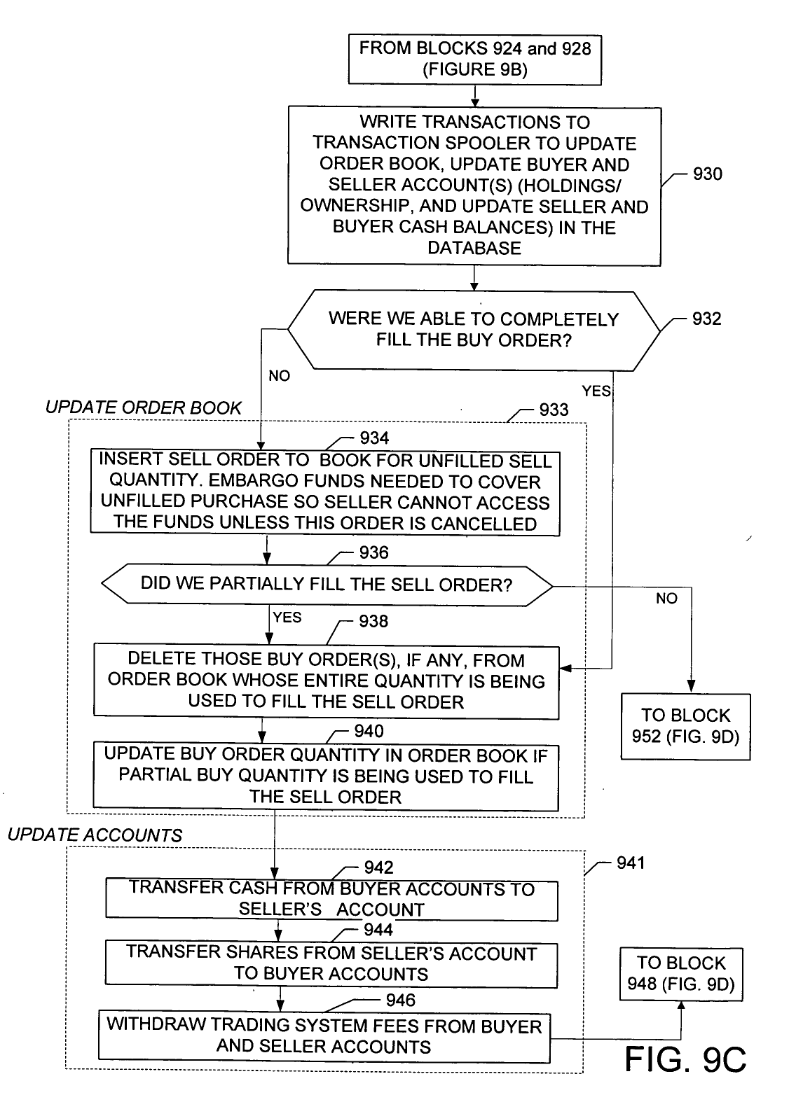

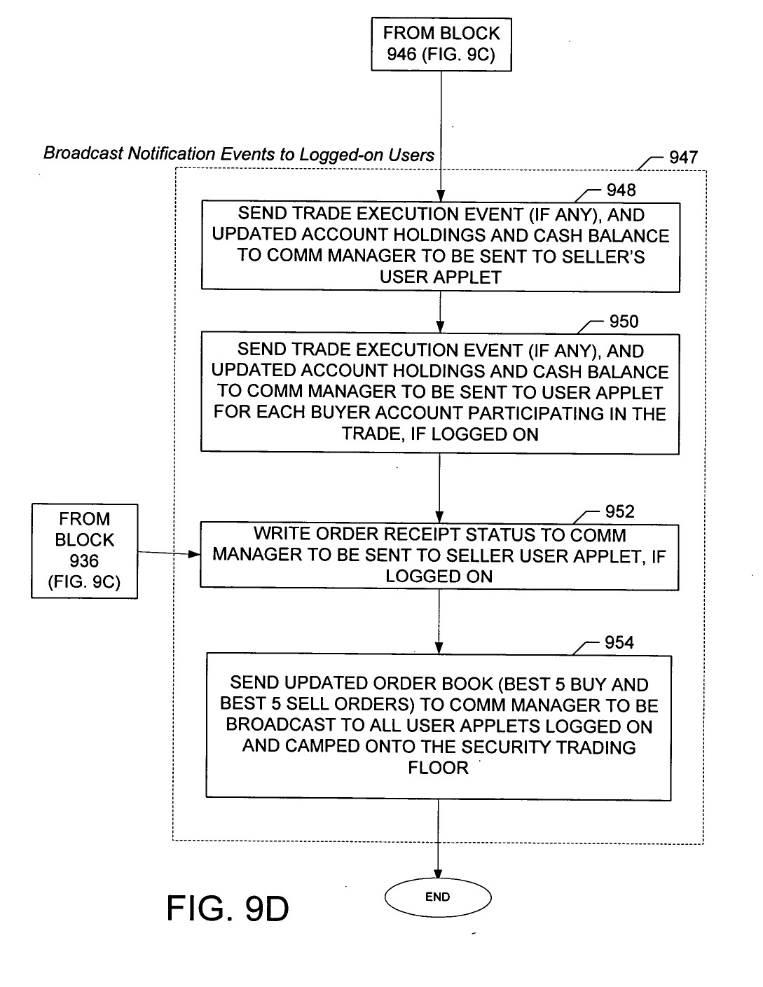

FIGS. 8A-8D collectively (FIG. 8) form a flow diagram of a method of reconciling orders to buy securities utilizing the securities trading system. Software, code, or instructions implementing the blocks of the flow diagram may be stored in and executed by the computing device 700. For ease of description, reference numbers from FIG. 2 are used to describe components affected by the flow diagrams of FIGS. 8 and 9. Moreover, one of ordinary skill in the art will recognize that the processes depicted in FIGS. 8 and 9 may be carried out using other components.

The buy order process 800 for each user begins operation upon a Stock Specialist's 220 receipt of a buy order from a user (block 802). The system checks the user's account and determines whether the system can accept buy orders from this account (e.g., the user's account is not suspended or frozen, the user is approved for trading, the user made the required minimum deposit, etc.) (block 804). If the system cannot accept buy orders, an “order rejected” record is written to the Production Transaction Spooler 222 and no change is made to the order book (block 806). Thereafter, the Stock Specialist 220 writes the order failure status to the CommManager 216 to be sent to the user applet (block 808).

If the system is able to accept buy orders from the user's account, the system checks the security to determine whether buy orders may be accepted for this security (e.g., trading of the security is halted, etc.) (block 810). If the system cannot accept buy orders for the security, an “order rejected” record is written to the Production Transaction Spooler 222 and no change is made to the order book (block 806). Thereafter, the Stock Specialist 220 writes the order failure status to the CommManager 216 to be sent to the user applet (block 808).

If the system is able to accept the buy order for the security, the system then determines whether the order is a market, limit, or “fill or kill at price” order (block 812). A market order is one where the user agrees to purchase a specified amount of securities at the available market price. A limit order occurs when the user indicates a quantity of securities to be purchased only below a price specified by the user. If all sell prices are above this amount, the buy order remains suspended for a predetermined period of time until either an available sell price at or below the price specified by the user becomes available or the predetermined period of time runs out, at which time the order terminates. Finally, a fill or kill at price order is a type of limit order whereby the order must be completely filled at the user specified price or it is immediately cancelled. That is, the predetermined time for filling this type of limit order, before the order terminates, is zero minutes.

If the buy order is a market order, the system determines if there is a buy price for the security—e.g., there are securities for sale (block 814). If there is not a buy price available for the security—e.g., there are no securities for sale—an “order rejected” record is written to the Production Transaction Spooler 222 and no change is made to the order book (block 806). Thereafter, the Stock Specialist 220 writes the order failure status to the CommManager 216 to be sent to the user applet (block 808). If there are securities for sale, the system retrieves the best (i.e., “lowest”) sell price from the order book (block 814). As a user does not specify a buy price for a market order, this price will be used as the buy price.

Once the system determines the buying price, the system determines whether the order is valid (block 818). Likewise, if the system determines that the order is a limit order or a fill or kill at price order in block 812, the system next determines if the order is valid (block 818). In one example, the system determines whether the buy quantity is valid based on security limits and/or the user's account limits. In addition, the system determines whether the offer price is within acceptable limits, the user's account has adequate available funds to cover the purchase price plus fees, etc. It is at this step that the system checks the buyer's account to ensure delivery of the requisite funds to fulfill the transaction. If the system determines that the transaction is invalid, an “order rejected” record is written to the Production Transaction Spooler 222 and no change is made to the order book (block 806). Thereafter, the Stock Specialist 220 writes the order failure status to the CommManager 216 to be sent to the user applet (block 808).

If the system determines that the order is valid, the order matching process begins (block 819). To begin, the system determines if there is a sell order for the security (block 820). As the system looked at the presence of a sell order for market orders in block 814, there will always be a sell order for market orders for at least the first loop of the order matching process 819. For limit and fill or kill at price orders, however, this is the first time the system looks for available sell orders.

If there is no sell order, the system looks to whether the order is a market, limit, or fill or kill at price order (block 824). If the order is either a market order or a fill or kill at price order, an “order rejected” record is written to the Production Transaction Spooler 222 and no change is made to the order book (block 806). Thereafter, the Stock Specialist 220 writes the order failure status to the CommManager 216 to be sent to the user applet (block 808). Alternatively, in another example, the system may partially fill the market order to the extent there are available securities for sale.

If there is a sell order for the security, the system retrieves the best (i.e., “lowest”) sell order from the order book (block 822). In the event the transaction is a market order, the price of this sell order should match the sell price retrieved in block 816. In the event the system is completing the order matching loop 819 multiple times for the same security, as described in block 828 below, the system retrieves the best remaining sell price from the order book.

The system then determines whether the sell order price is less than or equal to the buy order price (block 826). If the buy order is a market order, the buy price was set in block 816 and therefore will always be equal to the sell price. Otherwise, the user manually specifies the buy price when placing the order. If the sell order price is greater than the buy order price, the system looks to whether the order is a market, limit, or fill or kill at price order (block 824). If the order is either a market order or fill or kill at market price order, an “order rejected” record is written to the Production Transaction Spooler 222 and no change is made to the order book (block 806). Thereafter, the Stock Specialist 220 writes the order failure status to the CommManager 216 to be sent to the user applet (block 808). If the order is a limit order, the system then updates the order book (block 830) as described in more detail below.

If the sell price is less than or equal to the buy order price, the system determines if the sell order quantity is greater than or equal to the buy order quantity (block 828). If the sell order quantity is less than the buy order quantity, there is an unfilled buy order remaining and the system returns to block 820 to see if there are additional sell orders.

If the sell quantity is greater than or equal to the buy order, the system updates the order book and writes the transactions to the Production Transaction Spooler 222 (block 830). In addition, the system updates the buyer's and seller's accounts to reflect the change in securities and cash balances. The Production Transaction Spooler 222 writes this transaction to the standby system 212 and to the Database Manager 228 which in turn records the transaction in the production database 230.

Thereafter, the system determines if the buy order was completely filled (block 832) before updating the order book (block 833). If the system did not completely fill the buy order, the system inserts the buy order into the order book for the unfilled buy quantity (block 834). In addition, the system embargos the funds needed to cover the unfilled purchase so the buyer cannot access the funds unless the order is cancelled.

The system then determines whether the order was partially filled (block 836). If the limit order was not even partially filled (i.e., it was not filled at all), no orders need to be removed from the order book and no accounts need to be updated. Therefore, the system writes an order receipt message to the CommManager 216 to be sent to the buyer's applet (block 852).

After the system embargos the buyer's funds, and in the event the system determines at block 832 that the buy order was at least partially filled, the system deletes those sell order(s), if any, whose entire quantity is being used to fill the buy order from the order book (block 838) and updates the sell order quantity in the order book if only a partial sell quantity is being used to fill the buy order (block 840).

The system then proceeds to update the users' accounts (block 841). Cash is immediately transferred from the buyer's account to the seller(s)' account(s) (block 842), shares are transferred from the seller(s)' account(s) to the buyer's account (block 844), and the trading system withdraws commission fees from the buyer's and/or seller(s)' accounts (block 846). The system is sure that the buyer has the adequate funds to complete the transaction because the system checked the buyer's account in block 818. In addition, as the trading system holds the buyer's funds and the seller(s)' securities, the system knows that the buyer's money and the seller(s)' securities are “good.” There is no worry that either user will back out of the deal or is using phony money/securities as the trading system holds all the users' money and securities. Block 841 represents the instantaneous settlement feature of the system.

Thereafter, the system broadcasts notification of the events to logged on users (block 847). To begin, the system sends the trade execution event (if any) and the updated account holdings and cash balances to the CommManager 216 to be sent to the user applet for each buyer (block 848) and seller (block 850) account participating in the trade, if logged on. In addition, the system writes the order status to the CommManager 216 to be sent to the buyer's user applet, if logged on (block 852). The system updates the order book by showing the highest five remaining buy orders and lowest five remaining sell orders and sends this to the CommManager 216 to be broadcast to all user applets logged on and camped onto the security trading floor (block 854).

Sell Order Reconciliation

FIGS. 9A-D collectively (FIG. 9) form a flow diagram of a method of reconciling orders to sell securities utilizing the securities trading system. Software, code, or instructions implementing the blocks of the flow diagram may be stored in and executed by the computing device 700. The sell order process 900 for each user begins operation upon a Stock Specialist's 220 receipt of a sell order from a user (block 902). The system checks the user's account and determines whether the system can accept sell orders from this account (e.g., the user's account is not suspended or frozen, the user is approved for trading, etc.) (block 904). If the system cannot accept sell orders, an “order rejected” record is written to the Production Transaction Spooler 222 and no change is made to the order book (block 906). Thereafter, the Stock Specialist 220 writes the order failure status to the CommManager 216 to be sent to the user applet (block 908).

If the system is able to accept sell orders from the user's account, the system checks the security to determine whether sell orders may be accepted for this security (e.g., trading of the security is halted, etc.) (block 910). If the system cannot accept sell orders for the security, an “order rejected” record is written to the Production Transaction Spooler 222 and no change is made to the order book (block 906). Thereafter, the Stock Specialist 220 writes the order failure status to the CommManager 216 to be sent to the user applet (block 908).

If the system is able to accept the sell order for the security, the system then determines whether the order is a market, limit, or “fill or kill at price” order (block 912). A market order is one where the user agrees to sell a specified amount of securities at the available market price. A limit order occurs when the user indicates a quantity of securities to sell only below a price specified by the user. If all buy prices are below this amount, the sell order remains suspended for a predetermined period of time until either an available buy price at or above the price specified by the user becomes available or the predetermined period of time runs out, at which time the order terminates. Finally, a fill or kill at price order is a type of limit order whereby the order must be completely filled at the user specified price or it is immediately cancelled. That is, the predetermined time for filling this type of limit order, before the order terminates, is zero minutes.

If the sell order is a market order, the system determines if there is a sell price for the security—e.g., there are securities to buy (block 914). If there is not a sell price available for the security—e.g., there are no securities to buy—an “order rejected” record is written to the Production Transaction Spooler 222 and no change is made to the order book (block 906). Thereafter, the Stock Specialist 220 writes the order failure status to the CommManager 216 to be sent to the user applet (block 908). If there are securities to buy, the system retrieves the best (i.e., “highest”) buy price from the order book (block 914). As a user does not specify a sell price for a market order, this price will be used as the sell price.

Once the system determines the selling price, the system determines whether the order is valid (block 918). Likewise, if the system determines that the order is a limit order or a fill or kill at price order in block 912, the system next determines if the order is valid (block 918). In one example, the system determines whether the sell quantity is valid based on security limits and/or the user's account limits. In addition, the system determines whether the offer price is within acceptable limits, the user's account has adequate available shares to cover the sell quantity, etc. The system may also perform additional checks to ensure the seller has ownership of and is able to sell the securities. It is at this step that the system checks the seller's accounts to ensure delivery of the requisite securities to fulfill the transaction. If the system determines that the transaction is invalid, an “order rejected” record is written to the Production Transaction Spooler 222 and no change is made to the order book (block 906). Thereafter, the Stock Specialist 220 writes the order failure status to the CommManager 216 to be sent to the user applet (block 908).

If the system determines that the order is valid, the order matching process begins (block 919). To begin, the system determines if there is a buy order for the security (block 920). As the system looked at the presence of a buy order for market orders in block 914, there will always be a buy order for market orders for at least the first loop of the order matching process 919. For limit and fill or kill at price orders, however, this is the first time the system looks for available sell orders.

If there is no buy order, the system looks to whether the order is a market, limit, or fill or kill at price order (block 924). If the order is either a market order or a fill or kill at price order, an “order rejected” record is written to the Production Transaction Spooler 222 and no change is made to the order book (block 906). Thereafter, the Stock Specialist 220 writes the order failure status to the CommManager 216 to be sent to the user applet (block 908). Alternatively, in another example, the system may partially fill the market order to the extent there are available buyers of a portion of the securities.

If there is a buy order for the security, the system retrieves the best (i.e., “highest”) buy order from the order book (block 922). In the event the transaction is a market order, the price of this buy order should match the buy price retrieved in block 916. In the event the system is completing the order matching loop 919 multiple times for the same security, as described in block 928 below, the system retrieves the best remaining buy price from the order book.

The system then determines whether the buy order price is more than or equal to the sell order price (block 926). If the sell order is a market order, the sell price was set in block 916 and therefore will always be equal to the buy price. Otherwise, the user manually specifies the sell price when placing the order. If the buy order price is less than the sell order price, the system looks to whether the order is a market, limit, or fill or kill at price order (block 924). If the order is either a market order or fill or kill at market price order, an “order rejected” record is written en to the Production Transaction Spooler 222 and no change is made to the order book (block 906). Thereafter, the Stock Specialist 220 writes the order failure status to the CommManager 216 to be sent to the user applet (block 908). If the order is a limit order, the system then updates the order book (block 930) as described in more detail below.

If the buy price is greater than or equal to the sell order price, the system determines if the buy order quantity is greater than or equal to the sell order quantity (block 928). If the buy order quantity is less than the sell order quantity, there is an unfilled sell order remaining and the system returns to block 920 to see if there are additional buy orders.

If the buy quantity is greater than or equal to the sell order, the system updates the order book and writes the transactions to the Production Transaction Spooler 222 (block 930). In addition, the system updates the buyer's and seller's accounts to reflect the change in securities and cash balances. The Production Transaction Spooler 222 writes this transaction to the standby system 212 and to the Database Manager 228 which in turn records the transaction in the production database 230.

Thereafter, the system determines if the sell order was completely filled (block 932) before updating the order book (block 933). If the system did not completely fill the sell order, the system inserts the sell order into the order book for the unfilled sell quantity (block 934). In addition, the system embargos the securities needed to cover the unfilled purchase so the seller cannot access the securities unless the order is cancelled.

The system then determines whether the order was partially filled (block 936). If the limit order was not even partially filled (i.e., it was not filled at all), no orders need to be removed from the order book and no accounts need to be updated. Therefore, the system writes an order receipt message to the CommManager 216 to be sent to the seller's applet (block 952).

After the system embargos the seller's securities, and in the event the system determines at block 932 that the sell order was at least partially filled, the system deletes those buy order(s), if any, whose entire quantity is being used to fill the sell order from the order book (block 938) and updates the buy order quantity in the order book if only a partial buy quantity is being used to fill the sell order (block 940).

The system then proceeds to update the users' accounts (block 941). Cash is immediately transferred from the seller's account to the buyer(s)' account(s) (block 942), shares are transferred from the buyer(s)' account(s) to the seller's account (block 944), and the trading system withdraws commission fees from the buyer's and/or seller(s)' accounts (block 946). The system is sure that the seller has the adequate securities to complete the transaction because the system checked the seller's account in block 918. In addition, as the trading system holds the buyer's funds and the seller(s)' securities, the system knows that the buyer's money and the seller(s)' securities are “good.” There is no worry that either user will back out of the deal or is using phony money/securities as the trading system holds all the users' money and securities. Block 941 represents the instantaneous settlement feature of the system.

Thereafter, the system broadcasts notification of the events to logged on users (block 947). To begin, the system sends the trade execution event (if any) and the updated account holdings and cash balances to the CommManager 216 to be sent to the user applet for each seller (block 948) and buyer (block 950) account participating in the trade, if logged on. In addition, the system writes the order status to the CommManager 216 to be sent to the buyer's user applet, if logged on (block 952). The system updates the order book by showing the highest five remaining buy orders and lowest five remaining sell orders and sends this to the CommManager 216 to be broadcast to all user applets logged on and camped onto the security trading floor (block 954).

While the foregoing describes preferred embodiments of the invention, it will be obvious to those with ordinary skill in the art that other configurations may be implemented. The foregoing description has been presented for the purposes of illustration and description and is not intended to be exhaustive or to limit this patent to the examples disclosed. Many modifications and variations are possible in light of the above teachings. It is intended that the scope of the invention not be limited by this detailed description of examples.

1. A method of conducting instantaneous and simultaneous settlement supporting trading of securities, the method comprising:
tracking an account of a first entity, wherein the account of the first entity includes ownership of a publicly traded security;
tracking an account of a second entity, wherein the account of the second entity includes a measure of that entity's consideration;
facilitating a contemporaneous exchange of the first entity's ownership of the security and the measure of the second entity's consideration between the two entities upon agreement on price and quantity, wherein said exchange and simultaneous settlement occurs in real-time;

2. A method as defined in claim 1, wherein the first and second entities receive a trade and settlement confirmation indicating that the trade and settlement are complete in all respects.

3. A method as defined in claim 1, wherein the contemporaneous exchange does not utilize an external settlement agency.

4. A method as defined in claim 1, wherein the first entity's ownership of the security has been verified.

5. A method as defined in claim 1, wherein the first entity's right to offer the security is verified.

6. A method as defined in claim 1, wherein the account of the first entity contains the identification of and number of shares of the security held by the first entity.

7. A method as defined in claim 1, wherein the second entity's consideration has been verified.

8. A method as defined in claim 1, wherein the account of the second entity contains a representation of the second entity's consideration.

9. A method as defined in claim 1, wherein the measure of the second entity's consideration includes immediately available transferable funds from either the second entity's account or from another source guaranteeing immediately available transferable funds.

10. A method as defined in claim 1, wherein at least one computer stores the account of the first entity.

11. A method as defined in claim 1, wherein at least one computer stores the account of the second entity.

12. A method as defined in claim 1, wherein at least one computer stores the account of both the first and second entities.

13. A method as defined in claim 1, wherein each entity accesses its respective account over a network using a personal computer or other network connected device.

14. A method as defined in claim 1, wherein each entity accesses its respective account over a network using a securities trading system.

15. A method as defined in claim 14, wherein the securities trading system contains the account of the first entity and the account of the second entity.

16. A method as defined in claim 14, wherein one of the first entity and the second entity comprises a broker/dealer.

17. A method as defined in claim 14, wherein the securities trading system charges at least one entity an amount of money proportional to the value of the securities exchanged.

18. A method as defined in claim 14, wherein the securities trading system charges at least one entity an amount of money proportional to the value of the second entity's consideration given in exchange for the first entity's security.

19. A method as defined in claim 14, wherein the securities trading system charges at least one entity a fixed amount of money for each exchange of the security and currency between the first and second entities.

20. A method as defined in claim 14, wherein the securities trading system charges at least one entity a fee to use the securities trading system.

21. A method of conducting instantaneous and simultaneous settlement of securities, the method comprising:
maintaining a system for holding accounts of at least a first entity and a second entity;
exchanging an security from an entity outside of the system with the account of at least one of the first and second entities;
exchanging immediately available transferable funds from an entity outside of the system with the account of at least one of the first and second entities;
facilitating a contemporaneous exchange of the security and immediately available transferable funds between the first and second entities within the system upon agreement on price and quantity, wherein said exchange between the first and second entities occurs in real-time.

22. A method as defined in claim 1, wherein the first and second entities receive a trade and settlement confirmation indicating that the trade and settlement are complete in all respects.

23. A method as defined in claim 21, wherein the contemporaneous exchange does not utilize an external settlement agency.

24. A method as defined in claim 21, wherein the first entity's ownership of the security has been verified.

25. A method as defined in claim 21, wherein the first entity's right to offer the security is verified.

26. A method as defined in claim 21, wherein the account of at least one of the first and second entities contains the identification of and number of shares of the security held by each entity.

27. A method as defined in claim 21, wherein at least one computer stores the account of the first entity.

28. A method as defined in claim 21, wherein at least one computer stores the account of the second entity.

29. A method as defined in claim 21, wherein at least one computer stores the account of both the first and second entities.

30. A method as defined in claim 21, wherein each entity accesses its respective account over a network using a personal computer or other network connected device.

31. A method as defined in claim 21, wherein each entity accesses its respective account over a network using a securities trading system.

32. A method as defined in claim 31, wherein one of the first entity and the second entity comprises a broker/dealer.

33. A method as defined in claim 31, wherein the securities trading system charges at least one entity an amount of money proportional to the value of the immediately available transferable funds exchanged between the first and second entities.

34. A method as defined in claim 30, wherein the securities trading system charges at least one entity a fixed amount of money for each exchange of the security and immediately available transferable finds between the first and second entities.

35. A method as defined in claim 30, wherein the securities trading system charges at least one entity a fee to use the securities trading system.

36. An apparatus for instantaneous and simultaneous settlement supporting trading of securities, the apparatus comprising:
a tracker of an account of a first entity, wherein the account of the first entity includes a security;
a tracker of an account of a second entity, wherein the account of the second entity includes a measure of the second entity's consideration;
a facilitator for a contemporaneous exchange of the first entity's security and the measure of the second entity's consideration upon agreement on price and quantity, wherein said exchange occurs in real-time.

37. An apparatus as defined in claim 1, wherein the first and second entities receive a trade and settlement confirmation indicating that the trade and settlement are complete in all respects.

38. An apparatus as defined in claim 36, wherein the facilitator does not utilize an external settlement agency.

39. An apparatus as defined in claim 36, wherein a verifier verifies the first entity's ownership of the security.

40. An apparatus as defined in claim 36, wherein a verifier verifies that the first entity is allowed to offer the security for sale.

41. An apparatus as defined in claim 36, wherein the account of the first entity contains the identification of and number of shares of the security held by the first entity.

42. An apparatus as defined in claim 36, wherein a verifier verifies the second entity's consideration.

43. An apparatus as defined in claim 36, wherein the account of the second entity contains a representation of the second entity's consideration.

44. An apparatus as defined in claim 36, wherein the measure of the second entity's consideration includes immediately available transferable finds from either the second entity's account or from another source guaranteeing immediately available transferable funds.

45. An apparatus as defined in claim 36, wherein at least one computer stores the account of the first entity.

46. An apparatus as defined in claim 36, wherein at least one computer stores the account of the second entity.

47. An apparatus as defined in claim 36, wherein at least one computer stores the account of both the first and second entities.

48. An apparatus as defined in claim 36, wherein each entity accesses its respective account over a network using a personal computer or other network connected device.

49. An apparatus as defined in claim 36, wherein each entity accesses its respective account over a network using a securities trading system.

50. An apparatus as defined in claim 49, wherein one of the first entity and the second entity comprises a broker/dealer.

51. An apparatus as defined in claim 49, wherein a biller charges at least one entity a fee to use the securities trading system.

52. A machine accessible medium, storing machine readable instructions, the instructions being structured to cause an apparatus to:
present a link allowing a first entity to offer to sell at least one share of an security for value;
recognize that the link has been selected;
recognize the identification of, the number of shares of, and the value of the security offered for sale by the first entity;
receive a representation of the identification of, number of shares of, and the value of an securities selected by the first entity;
in response to receiving the representation of the identification of, number of shares of, and the value of the security selected by the first entity, verify that the first entity has an ownership interest in the selected number of shares of the selected security;
in response to verification that the first entity has an ownership interest in the selected number of shares of the selected security, display on a personal computer over a network the selected number of shares of and the value of the selected security offered for sale by the first entity;
present a link allowing a second entity to select to buy at least one share of the security offered for sale by the first entity;
recognize that the link has been selected;
recognize the number of shares selected;
receive a representation of the identification of, number of shares of, and the value of the security selected by the second entity;
in response to receiving the representation of the identification of, number of shares of, and the value of the security selected by the second entity, verify that the second entity has sufficient consideration to buy the number of shares of the security at the displayed value;
in response to verification that the second entity has sufficient consideration to buy the number of shares of the security at the displayed value, initiate the contemporaneous real-time exchange of the number of the first entity's shares of the security selected with the second entity for an amount of the second entity's consideration;
display the identification of and the value of the remaining number of shares of the selected security offered for sale by the first entity after removing the number of shares of the first entity's security exchanged with the second entity;

53. The machine accessible medium as defined in claim 52, wherein first and second entities receive a trade and settlement confirmation indicating that the trade and settlement are complete in all respects.

54. The machine accessible medium as defined in claim 52, wherein the machine accessible medium does not utilize an external settlement agency.

55. The machine accessible medium as defined in claim 52, wherein the value of the security is determined by the first entity.

56. The machine accessible medium as defined in claim 52, wherein the value of the security is determined by the market price of the security.

57. The machine accessible medium as defined in claim 52, wherein the apparatus stores information regarding each entity's consideration and rights to sell shares of securities.

58. The machine accessible medium as defined in claim 52, wherein the account of the first entity contains the identification of and number of shares of the security owned by the first entity.

59. The machine accessible medium as defined in claim 52, wherein the consideration in the account of the second entity contains the amount of the second entity's consideration.

60. The machine accessible medium as defined in claim 52, wherein the consideration is immediately available transferable funds from either the second entity's account or from another source guaranteeing immediately available transferable funds.

61. The machine accessible medium as defined in claim 52, wherein at least one computer stores the account of the first entity.

62. The machine accessible medium as defined in claim 52, wherein at least one computer stores the account of the second entity.

63. The machine accessible medium as defined in claim 52, wherein at least one computer stores the account of both the first and second entities.

64. The machine accessible medium as defined in claim 52, wherein each entity accesses its respective account over a network using a personal computer or other network connected device.

65. The machine accessible medium as defined in claim 52, wherein each entity accesses its respective account over a network using a securities trading system.

66. The machine accessible medium as defined in claim 65, wherein one of the first entity and the second entity comprises a broker/dealer.

67. The machine accessible medium as defined in claim 65, wherein the securities trading system charges at least one entity an amount of money proportional to the value of the consideration exchanged between the first and second entities.

68. The machine accessible medium as defined in claim 65, wherein the securities trading system charges at least one entity a fixed amount of money for each exchange of the security and consideration between the first and second entities.

69. The machine accessible medium as defined in claim 65, wherein the securities trading system charges at least one entity a fee to use the securities trading system.

70. A machine accessible medium, storing machine readable instructions, the instructions being structured to cause an apparatus to:
present a link allowing a first entity to offer to buy at least one share of an security for value;
recognize that the link has been selected;
recognize the identification of, the number of shares of, and the value of the security offered to be bought by the first entity;
receive a representation of the identification of, number of shares of, and the value of an securities selected by the first entity;
in response to receiving the representation of the identification of, number of shares of, and the value of the security selected by the first entity, verify that the first entity has sufficient consideration to buy the number of shares of the security at the offered value;
in response to verification that the first entity has sufficient consideration to buy the number of shares of the security at the offered value, display on a personal computer over a network the selected number of shares of and the value of the selected security offered to be bought by the first entity;
present a link allowing a second entity to select to sell at least one share of the security offered to be bought by the first entity;
recognize that the link has been selected;
recognize the number of shares selected;
receive a representation of the identification of, number of shares of, and the value of the security selected by the second entity;
in response to receiving the representation of the identification of, number of shares of, and the value of the security selected by the second entity, verify that the second entity has sufficient consideration to buy the number of shares of the security at the offered value;
in response to verification that the second entity has sufficient consideration to buy the number of shares of the security at the offered value, initiate the contemporaneous real-time exchange of an amount of the first entity's consideration for the number of securities selected by the second entity;
display the identification of and the value of the remaining number of shares of the selected security offered to be bought by the first entity after removing the number of shares of the second entity's security exchanged with the first entity;

71. The machine accessible medium as defined in claim 70, wherein first and second entities receive a trade and settlement confirmation indicating that the trade and settlement are complete in all respects.

72. The machine accessible medium as defined in claim 70, wherein the machine accessible medium does not utilize an external settlement agency.

73. The machine accessible medium as defined in claim 70, wherein the apparatus stores information regarding each entity's consideration and rights to sell shares of securities.

74. The machine accessible medium as defined in claim 70, wherein the consideration in the account of the first entity contains the amount of the first entity's consideration.

75. The machine accessible medium as defined in claim 70, wherein the consideration is immediately available transferable funds from either the second entity's account or from another source guaranteeing immediately available transferable funds.

76. The machine accessible medium as defined in claim 70, wherein the account of the second entity contains the identification of and number of shares of the security owned by the second entity.

77. The machine accessible medium as defined in claim 70, wherein at least one computer stores the account of the first entity.

78. The machine accessible medium as defined in claim 70, wherein at least one computer stores the account of the second entity.

79. The machine accessible medium as defined in claim 70, wherein at least one computer stores the account of both the first and second entities.

80. The machine accessible medium as defined in claim 70, wherein each entity accesses its respective account over a network using a personal computer or other network connected device.

81. The machine accessible medium as defined in claim 70, wherein each entity accesses its respective account over a network using a securities trading system.

82. The machine accessible medium as defined in claim 81, wherein one of the first entity and the second entity comprises a broker/dealer.

83. The machine accessible medium as defined in claim 81, wherein the securities trading system charges at least one entity an amount of money proportional to the value of the consideration exchanged between the first and second entities.

84. The machine accessible medium as defined in claim 81, wherein the securities trading system charges at least one entity a fixed amount of money for each exchange of the security and consideration between the first and second entities.

85. The machine accessible medium as defined in claim 81, wherein the securities trading system charges at least one entity a fee to use the securities trading system.

86. A computerized method of conducting instantaneous and simultaneous settlement supporting trading of securities, the method comprising:
managing an order book of buy and sell offers for a security via a first program;
communicating the buy and sell offers from the first program to a second program;
displaying the buy and sell offers to a first user and a second user via the second program;
facilitating the first user to enter a sell offer of the security into the order book;
communicating the first user's sell offer from the second program to the first program;
confirming the first user's ability to enter the sell offer;
listing the first user's sell offer in the order book upon confirmation that the first user has the ability to enter the sell offer;
facilitating the second user to accept the first user's sell offer in exchange for consideration;
communicating the second user's acceptance of the sell offer from the second program to the first program;
confirming the second user's ability to accept the sell offer;
upon confirmation that the second user has the ability to accept the sell offer, immediately initiating the simultaneous settlement of the transaction by transferring:
(i) the security from the first user's account to the second user's account and;
(ii) consideration from the second user's account to the first user's account;
updating the order book in response to the settlement of the transaction.

87. A method as defined in claim 86, wherein the first and second entities receive a trade and settlement confirmation indicating that the trade and settlement are complete in all respects.

88. A method as defined in claim 86, wherein the simultaneous settlement of the transaction does not utilize an external settlement agency.

89. A method as defined in claim 86, wherein the display of the second program comprises hypertext markup language, JavaScript, Java Server Pages, Java Applets, or Servlets.

90. A method as defined in claim 1, wherein the second entity's consideration includes immediately available transferable funds from either the second entity's account or from another source guaranteeing immediately available transferable funds.

91. A method as defined in claim 1, wherein the communication of the buy and sell offers occurs over a network.

92. A method as defined in claim 91, wherein the communication of the buy and sell offers occurs using a securities trading system.
